(19) United States
(12) Patent Application Publication
(10) Pub. No.: US 2026/0195539 A1
(43) Pub. Date: Jul. 9, 2026

(54) EVALUATING CONVERSATIONAL AGENT RESPONSE QUALITY USING QUERY SENTIMENT

(71) Applicant: Dell Products L.P., Round Rock, TX (US)

(72) Inventors: Ramakanth Kanagovi, HYDERABAD (IN); Rajan Kumar, NAWADA (IN); Guhesh Swaminathan, CHENNAI (IN)

(21) Appl. No.: 19/015,222

(22) Filed: Jan. 9, 2025

(51) Int. Cl. G06F 40/30; G06F 16/93; G06N 20/00

(52) U.S. Cl. CPC G06F 40/30; G06F 16/93; G06N 20/00

(57) ABSTRACT

Determination of implicit feedback from users with regard to query responses, and updating AI-based model, conversational agent (CA), or content retrieval process based on such feedback can be performed. In response to query from user, CA, employing the model, can provide query response to user. In response to query response, CA can receive, from user, a message that can be another query or a statement. Interaction manager (IM) can determine respective similarity scores between message and previous query-query response pair to determine QCS based on respective similarity scores. IM can determine average aspect based sentiment score (SS) of message based on analysis of message, and determine CASS based on QCS and SS. IM can determine whether message represents positive or negative feedback with respect to query response based on CASS and threshold CASS(s). IM can update model, content retrieval process, or CA based on such feedback.

### BACKGROUND

Conversational artificial intelligence (AI) systems, which can include conversational agents (e.g., chatbots), can be utilized to assist and provide information to users. Conversational agents can interact and have a dialog with users where users, for example, can communicate queries to the conversational agents, and the conversational agents can respond to the queries. A conversational agent can comprise or can be associated with an AI-based model that can be utilized to analyze and process a query, such as a natural language query or other type of query (e.g., from a user or device). Based on the analyzing and processing of the query, the AI-based model can analyze electronic documents, comprising various types of content, and can retrieve content from the electronic documents that can be responsive, or at least intended to be responsive, to the query. Based on the content retrieved from the electronic documents, the conversational agent can communicate a response to the query to the entity that submitted the query.

The above-described description is merely intended to provide a contextual overview regarding conversational AI systems and query processing, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise: in connection with a query response communicated by a conversational agent, via a conversational agent device, to a device associated with a user in response to a query received from the device, determining, by a system comprising at least one processor, a conditional aspect based sentiment score associated with a statement, received from the device in response to the query response, based on a result of evaluating statement data representative of the statement, wherein the statement can be based on user input associated with the user that can be obtained in response to the query response. The method also can comprise determining, by the system, whether the statement is classified as positive feedback associated with the user with respect to the query response based on the conditional aspect based sentiment score and a defined threshold conditional aspect based sentiment score that can be a positive feedback indicator.

In certain embodiments, the disclosed subject matter can comprise a system that can comprise at least one memory that can store computer executable components, and at least one processor that can execute computer executable components stored in the at least one memory. The computer executable components can comprise a score determinator that, with regard to a query response that can be transmitted by a conversational agent, via a first device, to a second device associated with a user in response to a query received from the second device, can determine a conditional aspect based sentiment score associated with a message received, via the second device based on input from the user, in response to the query response, based on a result of an analysis of message information representative of the message. The computer executable components also can comprise a feedback evaluator that can determine whether the message is representative of positive feedback associated with the user with respect to the query response based on the conditional aspect based sentiment score and a defined threshold conditional aspect based sentiment score that can indicate whether feedback is positive.

In still other embodiments, the disclosed subject matter can comprise a non-transitory machine-readable medium, comprising executable instructions that, when executed by at least one processor, can facilitate performance of operations. The operations can comprise: with regard to a query response communicated by an interactive agent, via a first device, to a second device, associated with a user identity that can identify a user, in response to a first query received from the second device, determining a conditional aspect based sentiment value associated with a message received from the second device in response to the query response based on a result of analyzing message information representative of the message associated with the user identity, wherein the message can be a second query or a user response to the query response. The operations further can comprise determining whether the message is indicative of positive feedback or negative feedback associated with the user identity with respect to the query response based on the conditional aspect based sentiment value and a defined threshold conditional aspect based sentiment criterion that can be indicative of feedback types comprising the positive feedback and the negative feedback.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably determine feedback (e.g., implicit feedback) of a user during an interaction with a conversational agent to facilitate managing, updating, and enhancing an artificial intelligence (AI)-based model associated with the conversational agent, a content retrieval process, and/or the conversational agent, in accordance with various aspects and embodiments of the disclosed subject matter.

FIG. 2 depicts a block diagram of a system that can comprise the conversational agent, interaction manager component, AI component, document retrieval manager component, and other components to facilitate desirably determining feedback (e.g., implicit feedback) of users during interactions with conversational agents to facilitate managing, updating, and enhancing the AI-based model(s) associated with the conversational agents, content retrieval process, and/or conversational agents, in accordance with various aspects and embodiments of the disclosed subject matter.

FIG. 3 presents a diagram of an example scenario of an interaction between a user and the conversational agent (and associated AI-based model) where the second query of the user is determined to have a positive sentiment and can be representative of positive feedback with respect to the query response of the conversational agent to the previous query of the user, in accordance with various aspects and embodiments of the disclosed subject matter.

FIG. 4 presents a diagram of an example scenario of an interaction between a user and the conversational agent (and associated AI-based model) where the second query of the user is determined to have a negative sentiment and can be representative of negative feedback with respect to the query response of the conversational agent to the previous query of the user, in accordance with various aspects and embodiments of the disclosed subject matter.

FIG. 5 presents a diagram of an example scenario of an interaction between a user and the conversational agent (and associated AI-based model) where the second query of the user is determined to have a neutral/positive sentiment and can be representative of positive feedback with respect to the query response of the conversational agent to the previous query of the user, in accordance with various aspects and embodiments of the disclosed subject matter.

FIG. 6 illustrates a flow chart of an example method that can desirably determine feedback (e.g., implicit positive or negative feedback) of a user during an interaction with a conversational agent to facilitate managing, updating, and enhancing an AI-based model associated with the conversational agent, a content retrieval process, and/or the conversational agent, in accordance with various aspects and embodiments of the disclosed subject matter.

FIGS. 7 and 8 illustrate a flow chart of another example method that can desirably determine feedback (e.g., implicit positive or negative feedback) of a user during an interaction with a conversational agent to facilitate managing, updating, and enhancing an AI-based model associated with the conversational agent, a content retrieval process, and/or the conversational agent, in accordance with various aspects and embodiments of the disclosed subject matter.

FIG. 9 depicts a flow chart of an example method that can desirably update and enhance an AI-based model associated with the conversational agent, a content retrieval process, and/or the conversational agent based at least in part on feedback (e.g., implicit positive or negative feedback) of a user with respect to a query-query response interaction between the user and the conversational agent, in accordance with various aspects and embodiments of the disclosed subject matter.

FIG. 10 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, methods, and techniques that can desirably (e.g., automatically, suitably, efficiently, reliably, enhancedly, and/or optimally) determine feedback (e.g., implicit feedback) of users during interactions with a conversational agent to facilitate managing, updating, and enhancing an artificial intelligence (AI)-based model associated with a conversational agent, a content retrieval process, and/or the conversational agent with regard to processing and responding to queries of users, in accordance with various aspects and embodiments of the disclosed subject matter. Conversational AI systems, which can include conversational agents (e.g., chatbots), can be utilized to assist and provide information to users. Conversational agents can interact and have a dialog with users where users. For instance, users (e.g., utilizing devices) can communicate queries to the conversational agents, and the conversational agents can communicate query responses to the users. A conversational agent can comprise or can be associated with an AI-based model (e.g., a large language model (LLM) or other type of AI-based model) that can be utilized to analyze and process a query, such as a natural language query or other type of query (e.g., from a user or device). Based on an analysis of the query, electronic documents, comprising various types of content, that may be relevant to the query can be determined and input to the AI-based model. The content of the electronic documents, for example, can be embedded or vectorized to facilitate searching for responses to queries. The AI-based model can analyze the query and the electronic documents (e.g., the AI-based model can search the embedded or vectorized content of the electronic documents based on the query), and can retrieve content from the electronic documents that can be responsive, or at least intended to be responsive, to the query. Based on the content retrieved from the electronic documents, the conversational agent can communicate a response to the query to the user (e.g., via the device) who submitted the query.

Conversational AI systems have evolved in recent years due in part to developments in generative pre-trained transformer (GPT) architectures. LLMs have recently gained popularity to assist users (e.g., external or internal users) to obtain concise and relevant answers to questions. With the ability to finetune the model and/or use retrieval augmented generation (RAG) (e.g., for document retrieval in connection with responding to queries), conversational agents, based on these LLMs, have become useful for responding to user queries.

One of the most common issues with existing LLMs can be hallucination. In response to queries, LLMs can tend to produce fabricated or incorrect outputs (e.g., query responses), which can challenge the trust that may be placed in these models. The reason for such hallucination by LLMs can be due in part to the LLM generating output base on word associations using probability scores. Along with this, training data utilized to train LLMs can introduce undesirable bias to the model. Consequently, researchers and companies can finetune these LLMs with more data and by employing techniques like reinforcement learning with human feedback (RLHF).

Often, existing techniques like RLHF can involve (e.g., can necessitate) a group of people having to spend significant time to evaluate the query responses by the LLM with the people giving human-based scores regarding the quality of the query responses for use in finetuning the LLM to obtain a more accurate and less hallucinated query response by the LLM. Some other existing techniques include requesting or soliciting user feedback (e.g., explicit user feedback) from users (e.g., users who have submitted queries to the conversational agent for submission to the LLM) via a chat window of the conversational agent, wherein such requesting or soliciting of the user feedback from the users can involve survey questions where the conversational agent can ask a user to answer the survey questions to obtain explicit user feedback regarding the quality of the query response by the LLM and/or can request that the user select a thumbs up button or a thumbs down button to explicitly provide some user feedback indicating the quality of the query response by the LLM, wherein there also may be follow up survey questions regarding the query response for the user to answer if the user selects the thumbs up button or thumbs down button. However, such existing techniques for requesting or soliciting explicit user feedback from the user often can be undesirably time consuming to the user, as the user often has to clearly mention what the expected response was as part of the feedback, and further, in many cases, users may not provide any explicit user feedback regarding the quality of the query response by the LLM and associated conversational agent.

The disclosed subject matter can employ systems, methods, techniques, and algorithms that can address and overcome the aforementioned deficiencies and other deficiencies of the existing systems and techniques. To that end, techniques that can desirably (e.g., automatically, dynamically, suitably, reliably, efficiently, enhancedly, and/or optimally) determine feedback (e.g., implicit feedback) of users during interactions with a conversational agent to facilitate managing, updating, and enhancing an AI-based model associated with a conversational agent, a content retrieval process, and/or the conversational agent with regard to processing and responding to queries of users, in accordance with various aspects and embodiments of the disclosed subject matter. In accordance with various embodiments, a system can comprise a conversational agent that can interact with (e.g., engage in voice or textual dialog with), and provide information to, users and/or devices associated with the users. For instance, the conversational agent can receive queries from users (e.g., via their devices or an interface of the conversational agent), and the conversational agent, employing an AI-based model (e.g., a trained AI-based model), can communicate query responses to the queries to the users. The system also can comprise a document retrieval manager component and a data store, which can comprise a database containing electronic documents comprising various and respective content. The document retrieval manager component can be associated with the AI-based model and the conversational agent. When a query is received by the conversation agent from a user, the document retrieval manager component can determine a desirable group of electronic documents that can be related to the query based at least in part on the results of analyzing the query, the electronic documents, and/or other information (e.g., metadata or other information associated with the electronic documents), can retrieve the group of electronic documents from the database, and can provide (e.g., communicate) the group of electronic documents to the AI-based model as input for analysis by the AI-based model along with the query.

In accordance with various embodiments, the system can comprise an interaction manager component that can be associated with the conversational agent, an AI component (e.g., comprising the AI-based model and a trainer component), the document retrieval manager component, and the data store. The interaction manager component can desirably (e.g., automatically, dynamically, suitably, reliably, efficiently, enhancedly, and/or optimally) determine feedback (e.g., implicit, derived, or inferred feedback) of users during interactions with the conversational agent based at least in part on user responses (e.g., second or subsequent query or message of user) to query responses, and, based at least in part on such feedback, can manage, update, and enhance the AI-based model, the content retrieval process, and/or the conversational agent with regard to processing and responding to queries of users.

For instance, during an interaction between a user (e.g., a user using a device) and the conversational agent, the conversational agent can receive a first query from the user, the conversational agent can communicate a query response to the user (e.g., as such query response can be determined or inferred using the trained AI-based model), and, subsequent to or in response to the query response, the conversational agent can receive a message (e.g., a second query or other statement) from the user. In some embodiments, the interaction manager component, employing a score determination component, can determine (e.g., calculate) respective similarity scores between the message and the previous query-query response pair to determine a query continuity score (QCS) based at least in part on the respective similarity scores. For instance, the score determination component can determine a first similarity score between the query and the message associated with the user based at least in part on results of analyzing the query and the message. The score determination component can determine a second similarity score between the query response and the message associated with the user based at least in part on results of analyzing the query response and the message. The score determination component can determine the QCS based at least in part on (e.g., as a function of) the first similarity score and the second similarity score.

In certain embodiments, a sentiment of the message of the user can be a proxy to define whether the user is satisfied with the query response. In some embodiments, to facilitate determining the sentiment of the message of the user, the score determination component can determine an overall (e.g., an average, a median, or other type of overall) aspect based sentiment score (SS) associated with the message based at least in part on the results of an analysis of the message (e.g., respective keywords of the message). In certain embodiments, the score determination component can determine a CASS associated with the message (and the interaction) based at least in part on (e.g., as a function of) the QCS and the SS associated with the message. The interaction manager component, employing a feedback evaluator component, can determine whether the message represents positive or negative feedback with respect to the query response based at least in part on the CASS associated with the message and a defined threshold CASS(s). The interaction manager component, employing an update component, can determine an update that can be made to the AI-based model, the conversational agent, and/or a content retrieval process for determining which electronic documents to retrieve (e.g., from a database) in connection with responding to queries of users, based at least in part on such feedback of the user, other feedback from another entity(ies), and/or other information. Based at least in part on update information of the update, the update component can update the AI-based model, the conversational agent, and/or the content retrieval process.

The disclosed subject matter, by employing the interaction manager component and associated AI-based models (e.g., trained and enhanced AI-based models), and the enhanced techniques described herein, can desirably (e.g., automatically, dynamically, suitably, reliably, efficiently, enhancedly, and/or optimally) determine feedback (e.g., implicit, derived, or inferred feedback) of users during interactions with a conversational agent, without having to explicitly request or solicit user feedback (e.g., request or solicit explicit user feedback using survey questions, thumbs up/down buttons, or other type of explicit feedback request) from the users (e.g., users who have submitted queries to the conversational agent) via an interface (e.g., a chat window or other interface) of the conversational agent. The disclosed subject matter, by employing the interaction manager component and associated AI-based models (e.g., trained and enhanced AI-based models), and the enhanced techniques described herein, to determine such feedback of users during user-conversational agent interactions can desirably (e.g., automatically, dynamically, suitably, reliably, efficiently, enhancedly, and/or optimally) reduce the amount of time and resources utilized by the system to determine feedback of users with respect to interactions between the users and the conversational agent (and associated AI-based model), can desirably enhance (e.g., improve, increase, or optimize) accuracy of query responses by the conversational agent (and associated AI-based model) to queries, can desirably reduce (e.g., decrease or minimize the amount of time and resources utilized by the system (e.g., conversational agent, AI-based, model, and/or other system components) for processing and responding to queries of users during interactions with users, can desirably reduce the amount of time utilized by users in connection with user-conversational agent interactions (e.g., reduce, minimize, or eliminate the amount of time a user may spend on answering survey questions, selecting thumbs up/down buttons, or performing other explicit user feedback tasks), can enhance (e.g., improve, increase, or optimize) performance of AI-based models, conversational agents, and/or document retrieval processes in connection with user-conversational agent interactions, and/or can reduce (e.g., decrease, minimize, or eliminate) the amount of time utilized to provision and implement existing explicit user feedback request or solicitation mechanisms (e.g., survey question mechanisms, thumbs up/down survey mechanisms, or other explicit user feedback request or solicitation mechanisms), as compared to existing systems, methods, and techniques for user-conversational agent interactions, query processing, content retrieval, and query responses.

These and other aspects and embodiments of the disclosed subject matter will now be described with respect to the drawings.

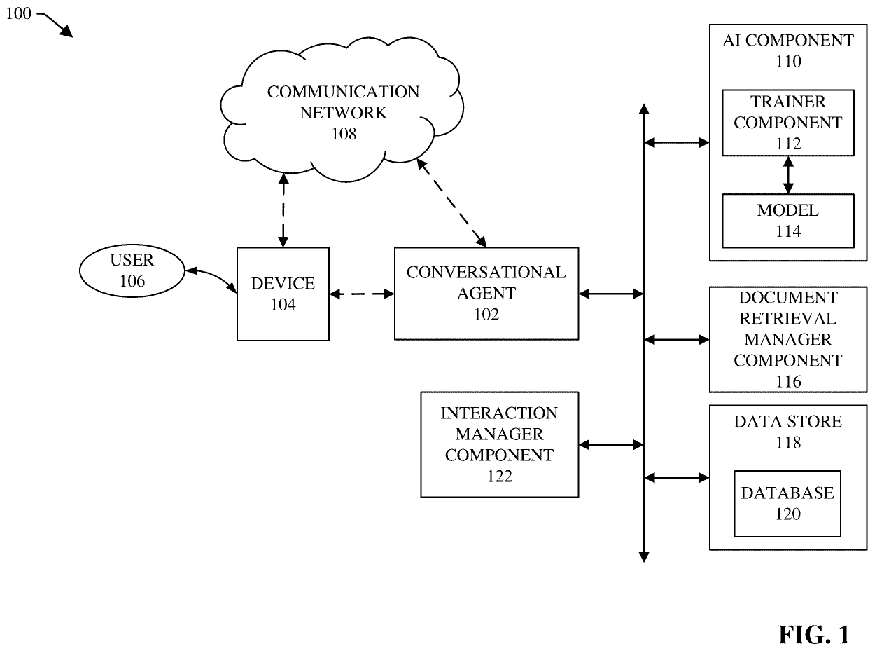

Referring now to the drawings, FIG. 1 illustrates a block diagram of a non-limiting example system 100 that can desirably (e.g., automatically, dynamically, suitably, reliably, efficiently, enhancedly, and/or optimally) determine feedback (e.g., implicit feedback) of a user during an interaction with a conversational agent to facilitate managing, updating, and enhancing an AI-based model associated with the conversational agent, a content retrieval process, and/or the conversational agent, in accordance with various aspects and embodiments of the disclosed subject matter. In accordance with various embodiments, the system 100 can comprise a conversational agent 102 (e.g., chatbot, virtual assistant (or virtual agent), interactive agent, or other type of conversational agent) and a device 104 that can be associated with (e.g., communicatively connected to) the conversational agent 102. In some embodiments, the conversational agent 102 can be, can be part of, or can be associated with a device (e.g., conversational agent device or other device). In certain embodiments, the conversational agent 102 can emulate (e.g., mimic) human dialogue (e.g., human voice, human textual content, or other human interaction). In some embodiments, the device 104 can be associated with a user 106 who can interact with (e.g., utilize) the device 104 to interact with the conversational agent 102, including sending queries or other messages to the conversational agent 102 and receiving query responses or other messages from the conversational agent 102. In certain other embodiments, the user 106 can interact directly with the conversational agent 102 (e.g., via an interface of the conversational agent 102), as an alternative to, or in addition to, interacting with the conversational agent 102 via the device 104. While the system 100 includes one conversational agent 102 and one device 104 (and one user 106), it is to be appreciated and understood that, in accordance with various embodiments, the system 100 can comprise a desired number (e.g., one or more) of conversational agents and a desired number of devices (and a desired number of users).

A device (e.g., the device 104 or conversational agent device) can be, for example, a computer, a laptop computer, a server, a data storage system or device, a wireless, mobile, or smart phone, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device.

In some embodiments, the conversational agent 102 and the device 104 can be associated with (e.g., communicatively connected to) a communication network 108 that can enable the conversational agent 102 and the device 104 to communicate information to each other via a wireline communication connection or wireless communication connection (e.g., via a wireline or wireless communication channel). The communication network 108, more generally, or a core network of the communication network 108, can comprise various network equipment (e.g., routers, gateways, transceivers, switches, access points, network functions, processor components, data stores, or other devices or network nodes) that can facilitate (e.g., enable) communication of information between respective items of network equipment of the communication network 108, and/or communication of information between the one or more devices (e.g., device 104, conversational agent device associated with the conversational agent 102, or other device) and the communication network 108. The communication network 108, including the core network, can provide or facilitate wireless or wireline communication connections and channels between the one or more devices, and/or respectively associated services or applications, and the communication network 108. For reasons of brevity or clarity, some of the various network equipment, components, functions, or devices of the communication network may not be explicitly shown or described herein.

In certain embodiments, to facilitate processing and responding to queries of users (e.g., user 106), the system 100 can comprise an AI component 110 that can comprise a trainer component 112 and one or more AI-based models 114. The trainer component 112 can be employed to train or update (e.g., further train or refine training of) the one or more AI-based models 114 (e.g., trained AI-based model(s) 114) based at least in part on training data, electronic documents, feedback information (e.g., implicit and/or explicit feedback) from users (e.g., users, such as the user 106, presenting queries), feedback information from certain other users (e.g., one or more analysts, technicians, engineers, managers, or other certain users with knowledge and expertise in updating AI-based models, electronic document retrieval systems and processes, and/or conversational agents), and/or other information. In accordance with various embodiments, the one or more AI-based models 114 can be or can comprise an AI model, a machine learning (ML) model, a neural network model, a transformer-based model, a graph mining model, or other type of AI-based model, such as described herein. The AI-based model 114 can be or can comprise, for example, an LLM, a language model (LM), a GPT-type model, or other type of AI-based model. Depending on the type of model, the AI-based model 114 can support a maximum token size for input (e.g., as a single input) of, for example, 8 thousand (K), 16K, 32K, 128K, 256K, or other maximum token size that can be greater than or less than 256K.

In accordance with various embodiments, the AI-based model(s) 114 can be associated with (e.g., communicatively connected to, part of, or otherwise associated with) the conversational agent 102. The AI-based model(s) 114 can perform AI-based analysis on queries (e.g., queries provided by or associated with users, such as the user 106), electronic documents, and/or other information to facilitate determining and generating responses to the queries, wherein the conversational agent 102 can provide (e.g., communicate or present) the responses to the queries to the users (e.g., the user 106, via the device 104).

In some embodiments, the system 100 can comprise a document retrieval manager component 116 and a data store 118 that can be associated with (e.g., communicatively connected to or part of) the document retrieval manager component 116. In certain embodiments, the document retrieval manager component 116 can be associated with the AI component 110 and/or the conversational agent 102. In some embodiments, the data store 118 can comprise a database 120 that can comprise electronic documents (e.g., tokenized, vectorized, and/or embedded information that can be representative of the electronic documents) that can comprise respective information (e.g., respective information on respective topics) that can be utilized to facilitate responding to queries. For instance, in response to a query from the user 106 to the conversational agent 102, the document retrieval manager component 116, employing a retrieval process (e.g., a RAG process or other electronic document retrieval process), can determine, from the electronic documents stored in the database 120, a group of electronic documents that can be related to (e.g., relevant or pertinent to) the query, can retrieve the group of electronic documents from the database 120 of the data store 118, and can input the group of electronic documents into the AI-based model 114 for analysis to facilitate determining a response to the query. In accordance with various embodiments, the document retrieval manager component 116 can employ the RAG process or another desired retrieval process to determine, from the electronic documents stored in the database 120, a desirable (e.g., suitable, enhanced, or optimal) group of electronic documents, that can be related to a particular query, and can retrieve the desirable group of electronic documents from the database 120 for input to the AI-based model 114.

In accordance with various embodiments, to facilitate enhancing (e.g., increasing, improving, or optimizing) the performance of the conversational agent 102, the AI-based model(s) 114, the document retrieval manager component 116, and/or other component, function, or process of the system 100, the system 100 can comprise an interaction manager component 122 that can determine (e.g., identify, detect, or classify) feedback (e.g., implicit feedback) of a user (e.g., the user 106) with respect to a query response of the conversational agent 102 to the user, based at least in part on a sentiment and/or tone of the user in a subsequent query or other message (e.g., other statement) of the user that can be received by the conversational agent 102 in response to the query response, without the interaction manager component 122, conversational agent 102, or other component of the system 100 having to explicitly (e.g., expressly) request, solicit, or prompt feedback relating to the query response from the user, such as described herein. In certain embodiments, the sentiment and/or tone of the message (e.g., subsequent query or other statement) of the user 106 during a user-conversational agent interaction can be a proxy to define whether the user 106 is satisfied with the query response presented by the conversational agent 102 to the user 106. The interaction manager component 122 can be associated with (e.g., communicatively connected to) the conversational agent 102, the AI component 110 (including the AI-based model(s) 114), the document retrieval manager component 116, and/or other components of the system 100 to facilitate desirable management (e.g., control) of interactions between conversational agents (e.g., conversational agent 102) and users (e.g., user 106) and/or devices (e.g., device 104).

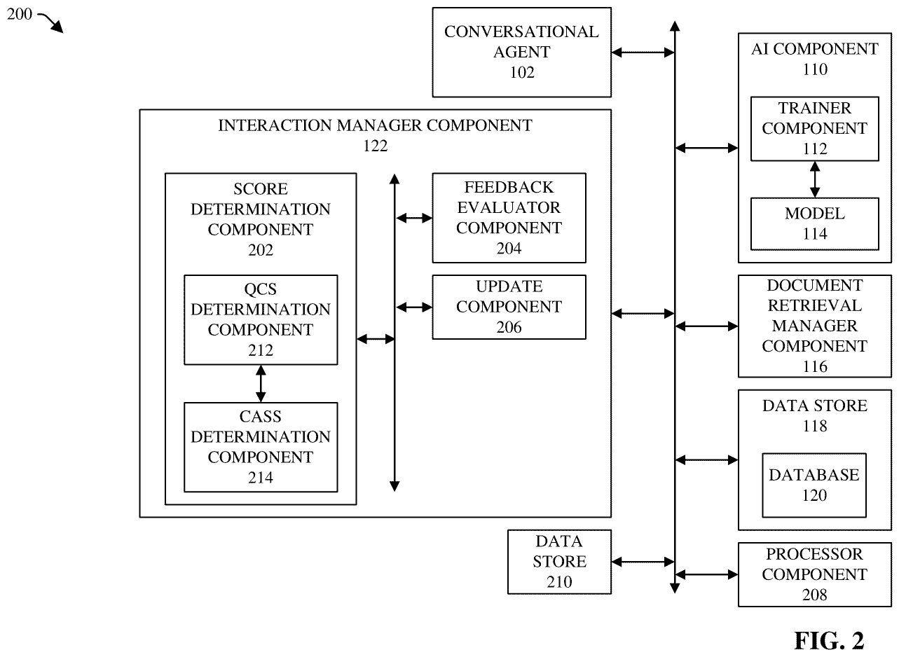

Referring to FIG. 2 (along with FIG. 1), FIG. 2 depicts a block diagram of a system 200 that can comprise the conversational agent 102, the interaction manager component 122, the AI component 110, the document retrieval manager component 116, and other components to facilitate desirably determining feedback (e.g., implicit feedback) of users during interactions with conversational agents to facilitate managing, updating, and enhancing the AI-based model(s) associated with the conversational agents, the content retrieval process, and/or the conversational agents, in accordance with various aspects and embodiments of the disclosed subject matter. In some embodiments, the system 100 can be part of the system 100 depicted in FIG. 1 and described herein. In accordance with various embodiments, the interaction manager component 122 can comprise and employ a number of components, including a score determination component 202, a feedback evaluator component 204, and an update component 206. The system 200 also can comprise a processor component 208 and a data store 210. In certain embodiments, the score determination component 202 can comprise a QCS determination component 212 and a CASS determination component 214. In accordance with various embodiments, the interaction manager component 122, the conversational agent 102, the AI component 110, the document retrieval manager component 116, the processor component 208, the data store 210, and/or other component can be associated with (e.g., communicatively connected to) each other. In accordance with various embodiments, the interaction manager component 122 (e.g., including the score determination component 202, feedback evaluator component 204, and/or the update component 206) can employ one or more trained AI-based models (e.g., one or more LLM or other AI-based models, which can be trained, updated, or refined by the AI component 110) that can perform, implement, and/or execute various functions, operations, processes, techniques, and/or algorithms of the interaction manager component 122, such as all or some of those various functions, operations, processes, techniques, and/or algorithms of the interaction manager component 122 described herein.

In some embodiments, the interaction manager component 122 can operate or function offline or partially offline. For instance, the interaction manager component 122 can operate or function such that it may not function in real time when the conversational agent 102 is engaging with end users (e.g., user 106). The interaction manager component 122 (or another component of the system 200) can record (e.g., automatically and incrementally record in real time) interactions and conversations between the conversational agent 102 and the users (e.g., user 106), and the interaction manager component 122 can perform analysis of interaction information relating to the interactions and conversations offline and/or at a desired time. Consequently, the analysis and/or other functions of the interaction manager component 122 can be performed without negatively impacting operation and functions of the conversational agent 102 during user-conversational agent interactions (e.g., the analysis and functions of the interaction manager component 122 can be performed such that they do not introduce latency into the user-conversational agent interactions). In certain other embodiments, at least some of the analysis of the interactions and conversations by interaction manager component 122 can be performed in real time or near real time, but in a manner where the real time interactions and conversations between the conversational agent 102 and the users cannot be negatively impacted (e.g., the analysis of the interactions and conversations by interaction manager component 122 can be performed such that it does not introduce latency into the user-conversational agent interactions).

In some embodiments, the conversational agent 102 can receive a query from the user 106 (e.g., via the device 104 or via an interface of or associated with the conversational agent 102). The conversational agent 102 can communicate the query to the interaction manager component 122, the document retrieval manager component 116, and/or the AI-based model 114. In certain embodiments, the document retrieval manager component 116 can determine a group of documents that can be related to (e.g., relevant to) the query based at least in part on the results of analyzing the query (e.g., query information of the query), the electronic documents stored in the database 120, and/or information relating to the electronic documents (e.g., stored in the data store 118), and/or other information. The document retrieval manager component 116 can communicate the group of documents (e.g., embedded, vectorized, and/or tokenized information that can be representative of the group of documents) to the AI-based model 114 for input to the AI-based model 114. The query (e.g., embedded, vectorized, and/or tokenized information that can be representative of the query) can be input to the AI-based model 114 (e.g., by the conversational agent 102, the interaction manager component 122, the document retrieval manager component 116, or another component). In some embodiments, the interaction manager component 122 (or another component) can embed, vectorize, and/or tokenize the query information of the query and can provide or facilitate providing such embedded, vectorized, and/or tokenized information representative of the query to the AI-based model 114.

The AI-based model 114 can perform an AI-based analysis on the query (e.g., embedded, vectorized, and/or tokenized query information that can be representative of the query) and the group of electronic documents (e.g., embedded, vectorized, and/or tokenized information that can be representative of the group of documents). Based at least in part on the results of such AI-based analysis of the query and the group of electronic documents, the AI-based model 114 can determine and generate query response information that can be, or can be utilized to generate, the query response to the query. In certain embodiments, as part of the analysis, the AI-based model 114 can perform a semantic search (e.g., a similarity or Euclidean distance search) on the vectorized electronic documents to find data “near” to the query tokens representative of the query, and can generate a query response based at least in part on the data (e.g., words) retrieved from the vectorized electronic documents. The query response information representative of the query response can be responsive to, or at least can be intended to be responsive to, the query, and can comprise a portion of the information, or other information derived from the information, of the group of electronic documents. The AI-based model 114 can communicate the query response information to the conversational agent 102. The conversational agent 102 can determine and/or generate a query response to the query based at least in part on the query response information (e.g., the query response can comprise or can be determined based at least in part on the query response information). The conversational agent 102 can provide (e.g., communicate) the query response to the user 106 (e.g., via the device 104, or via the interface of the conversational agent 102) for presentation (e.g., visual presentation, audio presentation, or other presentation) to the user 106.

In some embodiments, in response to receiving and perceiving (e.g., reading and/or evaluating) the query response, the user 106 (e.g., via the device 104 or the interface) can communicate a message (e.g., a second query or other message or statement) to the conversational agent 102, which can receive the message. If the message comprises the second query (as opposed to only a statement that is not a question), the second query may be, as some examples, a follow-up query relating to the original or previous query and indicating that the original or previous query was not answered to the satisfaction of the user 106, a follow-up query that may relate to something in the original or previous query, but can be somewhat different from the original or previous query (e.g., the original or previous query asked about a first feature of a product or service, and the second query asks about a second feature of the product or service), a query that may be a different or substantially different query that can be unrelated or substantially unrelated to the original or previous query (e.g., the original or previous query asked about a first product or service, and the second query asks about a second product or service), or may be some other type of query.

In some embodiments, the score determination component 202, employing the QCS determination component 212, can perform a query continuity analysis (e.g., an AI-based query or question continuity analysis) that can determine or detect a relationship between the message (e.g., second query or statement of the user 106) and the previous query-query response pair (e.g., the original or previous query of the user 106 and the query response to that query). Based at least in part on the results of such analysis, the QCS determination component 212 can determine (e.g., calculate) a QCS relating to the message and the previous query-query response pair. In certain embodiments, the QCS can be based at least in part on two components (e.g., elements), a first similarity score (e.g., a keywords similarity score (S1)) and a second similarity score (e.g., similarity score (S2)). For instance, the QCS determination component 212 can determine the first similarity score (S1) that can be representative of a relationship between the query (e.g., query information representative of the original or previous query of the user 106) and the message (e.g., message information representative of the message provided by the user 106 in response to the query response) based at least in part on the results of an analysis (e.g., an AI-based analysis or other analysis) of the respective keywords of the query and the message (e.g., respective first keywords of the query and respective second keywords of the message), wherein the first similarity score can be representative of the first level of similarity or the level of logical continuity between the query and the message. To facilitate determining the first similarity score, the QCS determination component 212 can determine, detect (e.g., find), and/or extract the respective first keywords of the query and the respective second keywords of the message, and can determine the first similarity score based at least in part on the results of analyzing the respective keywords of the query and the message, including determining the similarity between the respective keywords of the query and the message. In certain embodiments, as part of the analysis and determination of the first similarity score, the QCS determination component 212 can utilize the respective keywords and the similarity to obtain or determine a weighted score, which typically can perform better (e.g., can provide better results) as compared to just a cosine similarity analysis by itself. In accordance with various embodiments, the QCS determination component 212 can utilize techniques, such as cosine similarity, keyword extraction, and/or another desired technique for determining similarity, to determine the first similarity score. In some embodiments, the QCS determination component 212 can determine (e.g., calculate) the first similarity score (S1) utilizing the following equation:

$$S 1 = [ ( 1 + Jaccard Distance between keywords Q 1 \& Q 2 ) * similarity score of Q 1 \& Q 2 ] ,$$

wherein Q1 can be the original or previous query (e.g., question) of the user 106, and Q2 can be the message (e.g., the second query or statement) of the user 106. If the message (e.g., the second query or statement) is considered logically contiguous to the original or previous query, the message typically can exhibit a high similarity within the domain where the message is posed, and additionally, there likely can be matching keywords between the message and the original or previous query (e.g., there likely can be respective keywords between the message and the original or previous query that can satisfy a defined matching criterion that can indicate the respective keywords match, or at least substantially or sufficiently match, each other). In some embodiments, the QCS determination component 212 can employ or comprise an AI-based model (e.g., the trained AI-based model 114 or another trained AI-based model) that can determine the first similarity score. Such AI-based model can be, for example, an LLM, a transformer zero-shot model (e.g., key bidirectional encoder representations from transformers (KeyBERT), or other desired type of AI-based model. It is to be appreciated and understood that the above equation for determining S1 is merely one non-limiting example equation that can be utilized to determine S1, and in other embodiments, the QCS determination component 212 can determine (e.g., calculate) S1 utilizing another desired equation.

In certain embodiments, the QCS determination component 212 also can determine the second similarity score (S2) based at least in part on results of an analysis (e.g., an AI-based analysis or other analysis) of the query response (e.g., query response information representative of the query response provided by the conversational agent 102 and/or AI-based model 114) and the message (e.g., message information representative of the message provided by the user 106 in response to the query response), wherein the second similarity score can be representative of a relationship and a level of similarity between the query response and the message. In some embodiments, the second similarity score can be representative of the level of similarity between the query response and the message, wherein the level of similarity (e.g., level of direct similarity) between the query response and the message can be derived (e.g., deduced by the QCS determination component 212) based at least in part on the results of the analysis of the query response and the message. In accordance with various embodiments, the QCS determination component 212 can determine the second similarity score (S2) using same or similar techniques that can be utilized to determine the first similarity score (S1), except that the analysis can relate to the query response and the message. In certain embodiments, the QCS determination component 212 can employ or comprise an AI-based model (e.g., the AI-based model 114 or another AI-based model) that can determine the second similarity score.

In some embodiments, the QCS determination component 212 can determine the QCS based at least in part on (e.g., as a function of) the first similarity score (S1) and the second similarity score (S2). For example, the QCS determination component 212 can determine (e.g., calculate) the QCS as the sum of the first similarity score and the second similarity score (e.g., QCS=S1+S2). As another example, the QCS determination component 212 can determine the QCS as the sum or combination of a first weighted similarity score and a second weighted similarity score, wherein the QCS determination component 212 can determine the first weighted similarity score based at least in part on a first weight value and the first similarity score (e.g., first weight value multiplied by the first similarity score), and can determine the second weighted similarity score based at least in part on a second weight value and the second similarity score (e.g., second weight value multiplied by the second similarity score).

In some embodiments, the score determination component 202, employing the CASS determination component 214, can evaluate sentiment of the message (e.g., second query or statement) with respect to the query response. Sentiment of the message of the user 106 can be a proxy to facilitate defining whether the user 106 is satisfied with the query response from the conversational agent 102. The CASS determination component 214 can analyze the message (e.g., the message information representative of the message) and/or the query response (e.g., the query response information representative of the query response), and can determine, detect, and/or extract respective keywords of the message and/or query response, based at least in part on the results of such analysis. Utilizing a desired sentiment determination technique, and based at least in part on the analysis results, the CASS determination component 214 can determine (e.g., calculate) respective aspect based sentiment scores associated with respective aspect terms (e.g., respective keywords) of the message. In certain embodiments, the CASS determination component 214 can determine an overall aspect based sentiment score (SS) associated with the message based at least in part on (e.g., as a function of) the average or median score of the respective aspect terms (e.g., respective keywords) of the message. In some embodiments, the CASS determination component 214 can determine a CASS (e.g., a standardized or normalized CASS) associated with the message based at least in part on (e.g., as a function of) the QCS and the SS associated with the message. For example, the CASS determination component 214 can determine a CASS associated with the message utilizing the following equation:

$$CASS = QCS * SS associated with the message ,$$

wherein the SS associated with the message can be, or can be based at least in part on, the average or median score of the respective aspect terms of the message. It is to be appreciated and understood that the above equation for determining CASS is merely one non-limiting example equation that can be utilized to determine CASS, and in other embodiments, the CASS determination component 214 can determine (e.g., calculate) CASS utilizing another desired equation.

In some embodiments, the interaction manager component 122, employing the feedback evaluator component 204, can evaluate the interaction between the user 106 and the conversational agent 102, including the CASS, QCS, SS, and/or other information relating to the interaction, to determine whether the message (e.g., second query or statement) of the user 106 with respect to the query response of the conversational agent 102 (e.g., in response to the previous query of the user 106) can be representative of positive feedback or negative feedback. In accordance with various embodiments, the feedback evaluator component 204 can determine whether the message can be representative of (e.g., can be classified as or can be indicative of) positive feedback or negative feedback associated with the user 106 based at least in part on (e.g., as a function of) the CASS and a first defined threshold (e.g., higher threshold) CASS or a second defined threshold (e.g., lower threshold) CASS. For instance, the feedback evaluator component 204 can compare the CASS to the first defined threshold CASS and/or the second defined threshold CASS (e.g., if both the first defined threshold CASS and the second defined threshold CASS are being utilized).

The first defined threshold CASS can relate to a situation where, when the first defined threshold CASS is satisfied by the CASS, the sentiment associated with the message of the user 106 with respect to the query response can be positive (e.g., a scenario where the message of the user 106 indicates that the user 106 is satisfied with the query response, such as when message of the user 106 is a follow-up query about a different aspect of the topic of the previous query of the user 106, as opposed to a query asking about the same aspect of the topic again (e.g., in a same or different way)). An instance where the QCS and SS can be relatively higher can result in a relatively higher CASS that can satisfy (e.g., can meet or exceed; or can be at or greater than) the first defined threshold CASS. In some embodiments, the first defined threshold CASS can be set (e.g., by the feedback evaluator component 204 or an entity operating or managing the system 100) to a relatively higher value (e.g., 0.8, 0.9, 1.0, or another desired relatively higher value that can be higher or lower than 0.8).

The second defined threshold CASS can relate to a situation where, when the CASS satisfies (e.g., is at or below) the second defined threshold CASS, the sentiment associated with the message of the user 106 with respect to the query response can be positive or at least neutral (e.g., a scenario where the message of the user 106 indicates that the user 106 is satisfied with the query response, such as when message of the user 106 is a query about a different topic than the previous query of the user 106). An instance where the QCS can be low (e.g., at 0 or very low) and SS can be somewhat lower can result in a relatively low CASS (e.g., at 0 or very low) that can satisfy (e.g., can be at or lower than) the second defined threshold CASS. In some embodiments, the second defined threshold CASS can be set (e.g., by the feedback evaluator component 204 or the entity) to 0. In other embodiments, the second defined threshold CASS can be set at a relatively lower value that can be above, but near, 0 (e.g., 0.05, 0.10, 0.15, or another desired relatively lower value greater or less than 0.05 and near 0).

Based at least in part on the results of such comparison of the CASS to the first defined threshold CASS and/or the second defined threshold CASS, the feedback evaluator component 204 can determine whether the CASS associated with the message satisfies the first defined threshold CASS or the second defined threshold CASS (e.g., can determine whether the CASS is at or above the first defined threshold CASS or is at or below the second defined threshold CASS). If, based at least in part on the comparison results, the feedback evaluator component 204 determines that the CASS satisfies the first defined CASS or the second defined threshold CASS, the feedback evaluator component 204 can determine that the message can represent positive feedback associated with the user 106 with respect to the query response of the conversational agent 102. If, instead, based at least in part on the comparison results, the feedback evaluator component 204 determines that the CASS does not satisfy the first defined threshold CASS and the second defined threshold CASS (e.g., determines that the CASS is below the first defined threshold CASS and is above the second defined threshold CASS), the feedback evaluator component 204 can determine that the message can represent negative feedback associated with the user 106 with respect to the query response of the conversational agent 102.

It is to be appreciated and understood that, in certain embodiments, the feedback evaluator component 204, and associated techniques, processes, and algorithms, can be desirably more granular than determining only whether the message of the user 106 represents positive feedback or negative feedback (or positive/neutral feedback). In some embodiments, the feedback evaluator component 204, and associated techniques, processes, and algorithms, can employ one or more additional threshold CASS values (beyond the first and second threshold CASS) and/or a desired threshold QCS value(s) and/or a desired threshold SS value(s) to facilitate determining or classifying the type of feedback of a message of the user 106 with respect to the query response from the conversational agent 102. For example, the feedback evaluator component 204, and associated techniques, processes, and algorithms, can employ one or more additional threshold CASS values (beyond the first and second threshold CASS) and/or the desired threshold QCS value(s) and/or the desired threshold SS value(s) to enable the feedback evaluator component 204 to classify the type of feedback of a message of the user 106 with respect to the query response from the conversational agent 102 as being strongly positive feedback (e.g., if highest threshold CASS level or lowest threshold CASS level is determined to be satisfied by the feedback evaluator component 204), positive (e.g., somewhat positive) feedback (e.g., if higher (e.g., second-highest) threshold CASS level or lower (e.g., second-lowest) threshold CASS level is determined to be satisfied), negative (e.g., somewhat negative) feedback (e.g., if highest, second-highest, lowest, and second-lowest threshold CASS levels are determined to not be satisfied, and if a third-highest threshold CASS or a third-lowest threshold CASS is determined to be satisfied), or strongly negative feedback (e.g., if highest, second-highest, third-highest, lowest, second-lowest threshold, and third-lowest CASS levels are determined to not be satisfied by the feedback evaluator component 204).

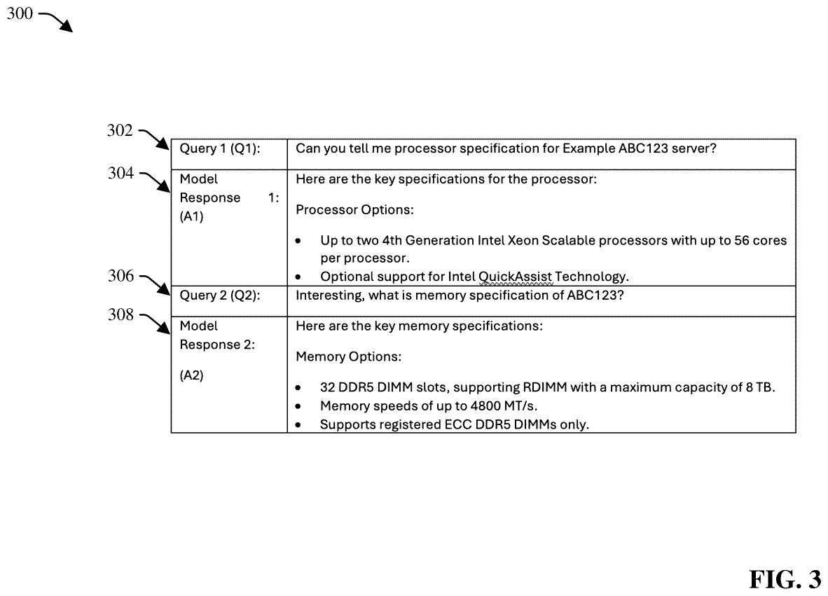

Referring to FIGS. 3-5 (along with FIGS. 1 and 2), FIGS. 3-5 present diagrams of non-limiting example scenarios of interactions between a user (e.g., user 106) and the conversational agent 102 (and associated AI-based model 114), in accordance with various aspects and embodiments of the disclosed subject matter. In the example scenarios, a group of electronic documents (e.g., user guides) relating to certain example products can be selected, and the text of the group of electronic documents can be extracted. In the example scenarios, a model such as a Beijing general embedding (BGE)-type model (e.g., BGE-large-en-v1-5) can be selected as the embedding model to embed the information of the electronic documents. For the example scenarios, the extracted text from the electronic documents can be properly chunked (e.g., segmented) based on the token limit of the embedding model, and the data chunks can be embedded and stored. For each of the example scenarios, a basic RAG pipeline can be constructed to retrieve the top number (e.g., top 5) chunks of data based on the cosine similarity between the user queries and the chunks of data. For each of the example scenarios, the user query and the top number of data chunks as the context can be input to an example LLM model (e.g., Mixtral-8x7b-instruct-v01), and the model (e.g., AI-based model 114) can generate a query response based on the user query and the data chunks.

FIG. 3 presents a diagram of an example scenario 300 of an interaction between a user (e.g., user 106) and the conversational agent 102 (and associated AI-based model 114) where the second query of the user is determined to have a positive sentiment and can be representative of positive feedback with respect to the query response of the conversational agent 102 to the previous query of the user, in accordance with various aspects and embodiments of the disclosed subject matter. In accordance with the example scenario 300, the conversational agent 102 can receive a first query 302 (Query 1 (Q1)) (as more fully shown in FIG. 3) from the user 106 (e.g., via the device or the interface). The AI-based model 114 can determine a query response 304 (A1) (as more fully shown in FIG. 3) to the first query 302 based at least in part on the results of performing an AI-based analysis on the first query 302 and a group of electronic documents determined to be related to the first query 302 by the document retrieval manager component 116. The conversational agent 102 can communicate the query response 304 (A1) to the user 106 (e.g., via the device or the interface). Subsequent to the query response 304 being provided to the user 106, the conversational agent 102 can receive a second query 306 (Query 2 (Q2)) (as more fully shown in FIG. 3) from the user 106 (e.g., via the device or the interface). The AI-based model 114 can determine a query response 308 (A2) (as more fully shown in FIG. 3) to the second query 306 based at least in part on the results of performing an AI-based analysis on the second query 306 and the group of electronic documents determined to be related to the second query 306 by the document retrieval manager component 116. The conversational agent 102 can communicate the second query response 308 (A2) to the user 106 (e.g., via the device or the interface).

In this example scenario 300, the second query 306 (Q2) can be in continuity with the first query 302 (Q1) and the first query response 304 (A1), and the second query 306 (Q2) from the user 106 can have a positive sentiment, as the user 106 can be asking a follow-up query (e.g., second query 306 (Q2)) to the previous (e.g., first) query 302. This can lead to the second query 306 (Q2) being considered positive feedback with respect to the first query response 304 (A1) and first query 302 (Q1). For instance, the example scenario 300 shows that the user 106, through the first query 302 (Q1), desires to know some specifications of a certain server product for which the AI-based model 114 responded with a specification, as indicated in the query response 304 (A1). Subsequently, the user 106 queried with a subsequent query (e.g., the second query 306 (Q2)), which is a continuation from the previous query, the user 106 desires to know about a different specification for the same server.

Using the technique, processes, and algorithms described herein, the score determination component 202 (e.g., employing the QCS determination component 212 and CASS determination component 214) can determine (e.g., calculate) the QCS=1.623 and SS=0.85, and correspondingly, the CASS=1.623*0.85=1.37, for this example scenario 300. The relatively high SS of 0.85 can indicate that the sentiment of the second query 306 (Q2)) with respect to the query response 304 (A1) can be positive, and the relatively high CASS of 1.37 can indicate that the second query 306 (Q2) with respect to the query response 304 (A1) can be representative of (e.g., classified as) positive feedback (e.g., the CASS of 1.37 can satisfy the first defined threshold CASS (e.g., 1.0 or other desired relatively higher threshold CASS).

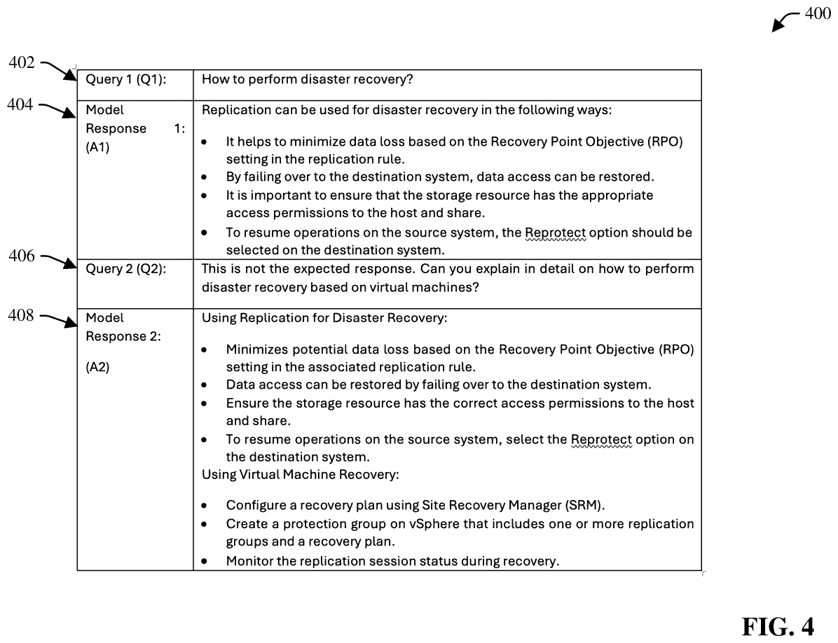

FIG. 4 presents a diagram of an example scenario 400 of an interaction between a user (e.g., user 106) and the conversational agent 102 (and associated AI-based model 114) where the second query of the user is determined to have a negative sentiment and can be representative of negative feedback with respect to the query response of the conversational agent 102 to the previous query of the user, in accordance with various aspects and embodiments of the disclosed subject matter. As presented in the example scenario 400, the conversational agent 102 can receive a first query 402 (Q1) from the user 106 (e.g., via the device or the interface), as more fully shown in FIG. 4. The AI-based model 114 can determine a query response 404 (A1) (as more fully shown in FIG. 4) to the first query 402 based at least in part on the results of performing an AI-based analysis on the first query 402 and a group of electronic documents determined to be related to the first query 402 by the document retrieval manager component 116. The conversational agent 102 can communicate the query response 404 (A1) to the user 106 (e.g., via the device or the interface). Subsequent to the query response 404 being provided to the user 106, the conversational agent 102 can receive a second query 406 (Query 2 (Q2)) (as more fully shown in FIG. 4) from the user 106 (e.g., via the device or the interface). The AI-based model 114 can determine a query response 408 (A2) (as more fully shown in FIG. 4) to the second query 406 based at least in part on the results of performing an AI-based analysis on the second query 406 and the group of electronic documents determined to be related to the second query 406 by the document retrieval manager component 116. The conversational agent 102 can communicate the second query response 408 (A2) to the user 106 (e.g., via the device or the interface).

In this example scenario 400, the second query 406 (Q2) can be in continuity with the first query 402 (Q1) and the first query response 404 (A1), and the second query 406 (Q2) from the user 106 can have a negative sentiment, as the user 106 is not satisfied with the query response 404, and hence, for the second query 406 of the user 106, the user 106 essentially asks the first query again using different words. This can lead to the second query 406 being considered negative feedback with respect to the first query response 404 (A1) and first query 402 (Q1). For instance, the example scenario 400 shows that the user 106, through the first query 402 (Q1), desires to know some procedure for which the AI-based model 114 responded with a specification, as indicated in the query response 404 (A1). Subsequently, the user 106 queried with a subsequent query (e.g., the second query 406 (Q2)), which can exhibit the dissatisfaction of the user 106 with respect to the query response 404, as, in the subsequent query, the user 106 essentially asks the same question again (e.g., essentially asks the first query again), only using more details.

Using the technique, processes, and algorithms described herein, the score determination component 202 can determine the QCS=1.754 and SS=0.19, and correspondingly, the CASS=1.754*0.19=0.33, for this example scenario 400. The relatively low SS of 0.19 can indicate that the sentiment of the second query 406 (Q2)) with respect to the query response 404 (A1) can be negative, and the relatively low CASS of 0.33 (e.g., relatively low, but not near 0) can indicate that the second query 406 (Q2) with respect to the query response 404 (A1) can be representative of (e.g., classified as) negative feedback (e.g., the CASS of 0.33 can be determined to not satisfy the first defined threshold CASS (e.g., 1.0 or other desired relatively higher threshold CASS), and also can be determined to not satisfy the second defined threshold CASS (e.g., 0 or other desired low threshold CASS).

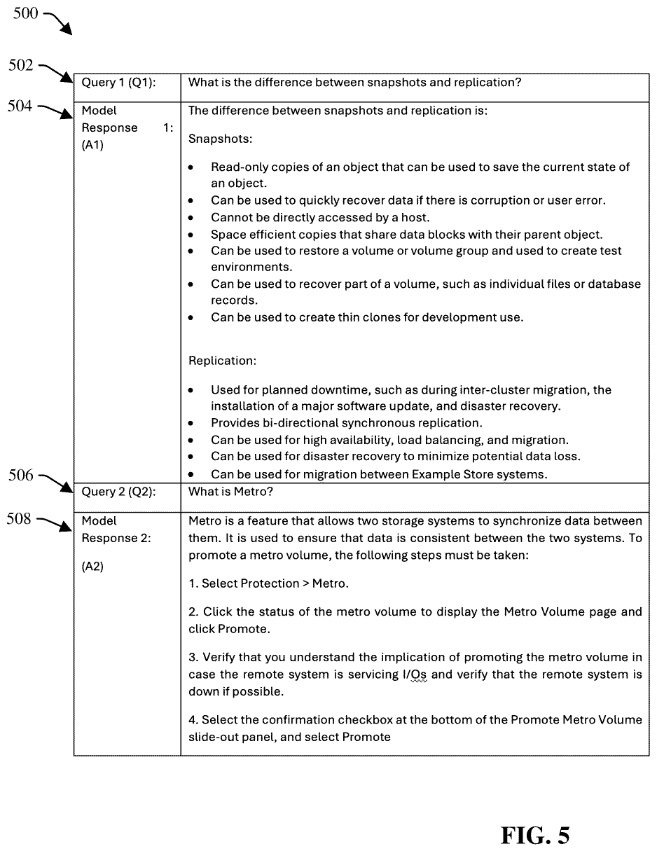

FIG. 5 presents a diagram of an example scenario 500 of an interaction between a user (e.g., user 106) and the conversational agent 102 (and associated AI-based model 114) where the second query of the user is determined to have a neutral/positive sentiment and can be representative of positive feedback with respect to the query response of the conversational agent 102 to the previous query of the user, in accordance with various aspects and embodiments of the disclosed subject matter. As presented in the example scenario 500, the conversational agent 102 can receive a first query 502 (Q1) (as more fully shown in FIG. 5) from the user 106 (e.g., via the device or the interface). The AI-based model 114 can determine a query response 504 (A1) (as more fully shown in FIG. 5) to the first query 502 based at least in part on the results of performing an AI-based analysis on the first query 502 and a group of electronic documents determined to be related to the first query 502 by the document retrieval manager component 116. The conversational agent 102 can communicate the query response 504 (A1) to the user 106 (e.g., via the device or the interface). Subsequent to the query response 504 being provided to the user 106, the conversational agent 102 can receive a second query 506 (Q2) (as more fully shown in FIG. 5) from the user 106 (e.g., via the device or the interface). The AI-based model 114 can determine a query response 508 (A2) (as more fully shown in FIG. 5) to the second query 506 based at least in part on the results of performing an AI-based analysis on the second query 506 and a group (e.g., another group) of electronic documents determined to be related to the second query 506 by the document retrieval manager component 116. The conversational agent 102 can communicate the second query response 508 (A2) to the user 106 (e.g., via the device or the interface).

In this example scenario 500, the second query 506 (Q2) is not in continuity with the first query 502 (Q1) and the first query response 504 (A1), and the second query 506 (Q2) from the user 106 can have a neutral/positive sentiment, as the user 106 can be satisfied with the query response 504, and, in the second query 506, the user 106 can be asking a question that can be significantly different from the first query 502. Hence, this can lead to the second query 506 (Q2) being considered positive feedback with respect to the first query response 504 (A1) and first query 502 (Q1). For instance, the example scenario 500 shows that the user 106, through the first query 502 (Q1), desires to know the difference between two procedures, and following the query response 504 (A1), the user 106 requests details regarding another procedure in the subsequent query (e.g., the second query 506 (Q2)). Here, it can be noted that the first query 502 (Q1) and the second query 506 (Q2) are significantly different (e.g., Q1 and Q2 relate to different procedures).

Using the technique, processes, and algorithms described herein, the score determination component 202 can determine the QCS=0 and SS=0.5, and correspondingly, the CASS=0*0.5=0, for this example scenario 500. The low SS (e.g., lowest possible SS) of 0 can indicate that the sentiment of the second query 506 (Q2)) with respect to the query response 504 (A1) can be positive (e.g., neutral/positive, which can be considered positive), and the low CASS (e.g., lowest possible CASS) of 0 can indicate that the second query 506 (Q2) with respect to the query response 504 (A1) can be representative of (e.g., classified as) positive (e.g., neutral/positive) feedback (e.g., the CASS of 0 can satisfy the second defined threshold CASS (e.g., 0 or other desired relatively lower threshold CASS that can be near 0).

In some embodiments, the respective QCS, SS, and CASS values associated with respective evaluations of interactions between users and conversational agent(s) (and associated AI-based model(s)) can be stored in a database in the data store 210. The interaction manager component 122 (e.g., employing the score determination component 202, the feedback evaluator component 204, or other component) and/or the entity (e.g., the entity operating or managing the system 100) can determine a joint distribution of these scores (e.g., respective QCS, SS, and CASS values) across respective types of scenarios (e.g., example scenarios 300, 400, and/or 500, and/or various other types of scenarios of interactions between users and conversational agents (and associated AI-based models)), and the interaction manager component 122 and/or the entity can utilize the joint distribution of these scores to determine respective cutoffs (e.g., respective threshold values, such as respective threshold CASS values, respective threshold QCS values, and/or respective SS values) for indicating or classifying positive and negative proxy feedbacks (or more granular feedback levels, such as described herein) by users (e.g., user 106) with respect to query responses of the conversational agent(s) (and associated AI-based model(s)) to queries of users. In certain embodiments, a determination of the joint distribution of respective QCS and SS values across respective types of scenarios can be desirably (e.g., suitably or sufficiently) useful, since CASS values can be based at least in part on QCS and SS values (e.g., can be based at least in part on the multiplication of QCS and SS values).

It is noted that an experiment was conducted for 100 sets of query-answer pairs to check for accuracy of the example agent (e.g., example or experimental interaction manager component) in predicting the correct feedback classification. These questions and answers were generated as ground truth using an LLM from individual data chunks or combination of multiple data chunks. Negative query-answer samples were randomly created by jumbling (e.g., disarranging, scrambling, or disrupting) some of the answers. A conversational setup was simulated to the LLM again. In this example simulation, the ground truth was known, and thereby the solution's joint distribution based determination of feedback of the user was deduced. In this experiment, out of the 100 sets of query-answer pairs, 87 sets of query-answer pairs were found to be matching with the ground truth, thereby providing that the disclosed solution to be working well, as a proof of concept, in determining, deriving, or inferring feedback (e.g., implicit feedback) of users with respect to interactions with conversational agents (and associated AI-based models). From the joint distribution based determination of user feedback in the experiment, example joint distribution and feedback classes (and associated cutoffs (e.g., threshold ranges)) were determined as follows:
Scenario 1 (e.g., example scenario 300): QCS=1.3 to 2.0, SS=0.6 to 1.0, and CASS=0.78 to 2.0 can be classified as positive feedback;
Scenario 2 (e.g., example scenario 400): QCS=1.5 to 2.0, SS=0 (e.g., greater than, but not equal to, 0) to 0.3, and CASS=0 (e.g., greater than, but not equal to, 0) to 0.6 can be classified as negative feedback; and
Scenario 3 (e.g., example scenario 500): QCS=0, SS=0.5, and CASS=0 can be classified as positive feedback.

It is to be appreciated and understood that, the interaction manager component 122 can determine and utilize different cutoff, threshold, or classification values for the respective scores (e.g., QCS, SS, and CASS) than those shown for the above experiment, as such other cutoff, threshold, or classification values may be determined from other joint distribution of such scores across respective types of scenarios, in accordance with various aspects and embodiments of the disclosed subject matter.

With further regard to the system 100, with the feedback evaluator component 204 having determined whether message (e.g., the second query or other statement) of the user 106 in response to the query response of the conversational agent 102 can be representative of positive feedback or negative feedback, the update component 206 (and/or the feedback evaluator component 204) can analyze the feedback information relating to that interaction between the user 106 and conversational agent 102, feedback information relating to other interactions between users and the conversational agent(s) (and associated AI-based model(s)), other feedback information from another entity (e.g., feedback from human users, such as technicians, engineers, or experts (e.g., subject matter experts or other experts)), and/or training-related information. The other entity (or entities) can comprise, for example, one or more analysts, technicians, engineers, managers, or other certain users with knowledge and expertise in updating AI-based models, electronic document retrieval systems and processes, and/or conversational agents. In some embodiments, the update component 206 (and/or the feedback evaluator component 204) can comprise or employ an AI-based model to perform an AI-based analysis on the feedback information relating to that interaction between the user 106 and conversational agent 102, other feedback information relating to the other interactions, other feedback information from the other entity, and/or training-related information.

Based at least in part on the results of such analysis, the update component 206 (and/or the feedback evaluator component 204) can determine and generate an update (e.g., comprising update information representative of the update) for the AI-based model 114, the electronic document retrieval process, and/or the conversational agent. If, for example, the feedback associated with the user 106 is determined to be negative, the update component 206 (and/or the feedback evaluator component 204, and/or the entity) can analyze and determine the reasons for the negative feedback with regard to the interaction between the user 106 and the conversational agent 102, can determine a desirable (e.g., suitable, enhanced, or optimal) corrective action that can rectify the problems that led to the negative feedback, and can determine an update that can enable the corrective action to be implemented. If, instead, the feedback associated with the user 106 is determined to be positive, the update component 206 (and/or the feedback evaluator component 204, and/or the entity) can determine that no update is to be performed at this time, or, alternatively, can determine and generate a reinforcement learning update that can reinforce the positive aspects relating to the interaction between the user 106 and the conversational agent 102.

In some embodiments, the update can comprise updating (e.g., modifying, adjusting, or altering) hyperparameters or parameters associated with the AI-based model 114, and/or applying (e.g., inputting) training data (e.g., by the trainer component 112) to the AI-based model 114, to facilitate refining (e.g., enhancing) the AI-based model 114 to facilitate enhancing determinations of query responses to queries by the AI-based model 114 and overall performance of the AI-based model 114, wherein the training data can be based at least in part on (e.g., can be derived from) the feedback associated with the user 106 relating to the interaction between the user 106 and the conversational agent 102 (and/or other feedback associated with one or more other users relating to one or more other interactions between the one or more other users and the conversational agent(s) (and associated AI-based model(s)). In certain embodiments, the update can comprise updating (e.g., modifying, adjusting, or altering) parameters or procedures associated with the operation of the conversational agent 102 to facilitate enhancing operation of the conversational agent 102 when responding to queries of users.

In some embodiments, the update can comprise updating (e.g., modifying, adjusting, or altering) parameters or procedures associated with the content retrieval process for determining which electronic documents to retrieve from the database 120 for input to the AI-based model(s) (e.g., AI-based model 114 or other AI-based model) to facilitate responding to a query of a user (e.g., user 106) by the conversational agent (e.g., conversational agent 102), to facilitate enhancing determinations of which electronic documents to retrieve from the database 120 for input to the AI-based model(s) to facilitate responding to queries of users by the conversational agent(s) (e.g., conversational agent 102 or other conversational agent). In certain embodiments, if the feedback of the user 106 (and/or the overall feedback of the user 106 and/or another entity) with regard to the query response to the query of the user 106 is determined to be positive feedback, the update can comprise caching information (e.g., query-query response pairs) relating to the interaction between the user 106 and the conversational agent 102 (e.g., caching the query and query response and/or other information of the interaction) in the database 120 (or other part of the data store 118) for future use if a same or similar query is received by the conversational agent 102 (or another conversational agent). In the future, if the same or similar query is received by the conversational agent 102 (or another conversational agent) from another user (or user 106), the document retrieval manager component 116 can quickly identify and retrieve (e.g., directly retrieve) the query response associated with that same query from the database 120 (or other part of the data store 118) based at least in part on an analysis (e.g., a relatively quick analysis) of the query of the other user (or the user 106), and the conversational agent 102 can quickly respond to the query of the other user (or the user 106), without a full and more intensive (e.g., more time and resource intensive) analysis of the query having to be performed by the document retrieval manager component 116 and/or the AI-based model 114 (e.g., without the document retrieval manager component 116 having to perform entire RAG process or other content retrieval process, and/or without the AI-based model 114 having to perform an AI-based analysis on a group of electronic documents retrieved from the database 120). By caching interaction information (e.g., information relating to respective queries and respective query responses) relating to interactions with certain positive feedback, time and resources of the system 100 can be saved, and the conversational agent 102 can more quickly, accurately, and/or efficiently respond to user queries for which the interaction information has been cached in the database 120 (or other part of the data store 118).

The update component 206 (and/or the trainer component 112 or the AI component 110) can respectively update or facilitate updating the AI-based model 114, the electronic document retrieval process of the document retrieval manager component 116, and/or the conversational agent 102 based at least in part on the update(s) (e.g., update information of the update(s)). As a result of performing such update(s), the respective performance of the AI-based model 114, the electronic document retrieval process of the document retrieval manager component 116, and/or the conversational agent 102 can be enhanced. The system 100, including the AI-based model 114, the document retrieval manager component 116, the conversational agent 102, and/or other components (e.g., as updated), can continue to receive, process, and respond to queries of users, such as described herein.

With further regard to the processor component 208 and the data store 210, the processor component 208 can employ one or more processors (e.g., one or more central processing units (CPUs)), accelerators, graphics processing units (GPUs), application-specific integrated circuits (ASICs), microprocessors, or controllers that can process information relating to data, files, the database, electronic documents, queries, query responses, tokens, vectorized, tokenized, and/or embedded content of electronic documents, token sizes, AI-based models, AI-related data, model training data, feedback information, update information, parameters (e.g., hyperparameters and other parameters), CASS values, QCS values, SS values, thresholds values (e.g., threshold CASS values or other threshold values), weight values, applications, services, devices, users, resources, data processing operations, messages, notifications, alarms, alerts, preferences (e.g., user or client preferences), hash values, metadata, traffic flows, tables, mappings, policies, defined query processing management criteria, algorithms (e.g., enhanced query processing management algorithms, enhanced feedback evaluation algorithms, content retrieval algorithms, conversational agent algorithms, update management algorithms, tokenization, vectorization, and/or embedding algorithms, hash algorithms, data compression algorithms, data decompression algorithms, and/or other algorithm), interfaces, application programming interfaces (APIs), protocols, tools, and/or other information, to facilitate operation of the interaction manager component 122 and the system 200, and control data flow between the interaction manager component 122 and/or other components (e.g., a computer-based system, a device (e.g., device 104), a conversational agent (e.g., conversational agent 102), the AI component 110, a node, an application, a service, a user (e.g., user 106), the communication network 108, network equipment or components, or other entity) associated with the interaction manager component 122 and the system 200.

The data store 210 can store data structures (e.g., user data, metadata), code structure(s) (e.g., modules, objects, hashes, classes, procedures) or instructions, information relating to data, files, the database, electronic documents, queries, query responses, tokens, vectorized, tokenized, and/or embedded content of electronic documents, token sizes, AI-based models, AI-related data, model training data, feedback information, update information, parameters (e.g., hyperparameters and other parameters), CASS values, QCS values, SS values, thresholds values (e.g., threshold CASS values or other threshold values), weight values, applications, services, devices, users, resources, data processing operations, messages, notifications, alarms, alerts, preferences, hash values, metadata, traffic flows, tables, mappings, policies, defined query processing management criteria, algorithms (e.g., enhanced query processing management algorithms, enhanced feedback evaluation algorithms, content retrieval algorithms, conversational agent algorithms, update management algorithms, tokenization, vectorization, and/or embedding algorithms, hash algorithms, data compression algorithms, data decompression algorithms, and/or other algorithm), interfaces, APIs, protocols, tools, and/or other information, to facilitate controlling or performing operations associated with the interaction manager component 122 and the system 200. The data store 210 can comprise volatile and/or non-volatile memory, such as described herein. In an aspect, the processor component 208 can be functionally coupled (e.g., through a memory bus) to the data store 210 in order to store and retrieve information desired to operate and/or confer functionality, at least in part, to the score determination component 202, feedback evaluator component 204, update component 206, processor component 208, data store 210, conversational agent 102, AI component 110, AI-based model 114, document retrieval manager component 116, and/or other component of or associated with the interaction manager component 122, and/or substantially any other operational aspects of the interaction manager component 122 and the system 200.

As disclosed, the data store 210 (or the data store 118) can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

With further regard to the AI component 110 and the AI-based models (e.g., AI-based model 114 and/or other AI-based models), the AI component 110 can perform or facilitate performing (e.g., can employ one or more models (e.g., LLM, LM, BERT-type model, KeyBERT, a GPT-type model, a BGE-type model, or other desired type of AI-based model to perform) AI-based analysis on data and generate AI-based analysis results, in accordance with various aspects and embodiments of the disclosed subject matter.

In some embodiments, the AI component 110 can comprise or be associated with the trainer component 112, and the one or more AI-based models, including AI-based model 114. The trainer component 112 can input training data, feedback-related data, and/or other data into a model (e.g., AI-based model 114 or other AI-based model) to facilitate training or refining training (e.g., updating or further training) the model, wherein the model can analyze the training data, feedback-related data, and/or other data as part of the training of the model. In certain embodiments, the model can be pre-trained, and the trainer component 112 can be employed to facilitate updating training of the model.

In accordance with various embodiments, the AI component 110 can employ, build (e.g., construct or create), and/or import, AI-based techniques and algorithms, AI-based models, transformer-based models, neural networks, LLMs, decision trees, Markov chains (e.g., trained Markov chains), and/or graph mining models to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining a response to a query (e.g., with regard to AI-based model 114), determining QCS, SS, and/or CASS values associated with an interaction between a user (e.g., user 106) and a conversational agent (e.g., interaction comprising a first query presented to the conversational agent 102 by the user 106; query response presented by the conversational agent 102 to the user, wherein the conversational agent 102 can employ the trained AI-based model 114 to determine or infer the query response; and a message (e.g., comprising a second query or statement) presented by the user 106 to the conversational agent 102 in response to or subsequent to the query response, determining feedback (e.g., implicit positive or negative feedback, or other feedback) of the user (e.g., user 106) with respect to the query response presented to the user by the conversational agent (e.g., conversational agent 102, employing the trained AI-based model 114 to determine or infer the query response) in response to the query (e.g., first, initial, or previous query) of the user presented to the conversational agent, determining an embedding, token, or vector for an electronic document, performing other desired functions or operations, and/or automating one or more functions or features of the disclosed subject matter, as more fully described herein.

The AI component 110 and the model(s) (e.g., AI-based model 114 and/or other AI-based model) can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 110 and/or the model(s) (e.g., AI-based model 114 and/or other AI-based model) can examine the entirety or a subset of the data (e.g., the training data; tokenized, vectorized, and/or embedded data; label data; the feedback-related information; operational data; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 110 and/or the model(s) (e.g., AI-based model 114 and/or other AI-based model) can employ a classifier that can perform an AI-based analysis on data. A classifier can map an input attribute vector, z=(z1, z2, z3, z4, . . . , zn), to a confidence that the input belongs to a class, as by f (z)=confidence (class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

It is to be appreciated and understood that one or more components (e.g., the document manager component, processor component, models, devices, or other components) of the systems (e.g., the system 100, the system 200, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

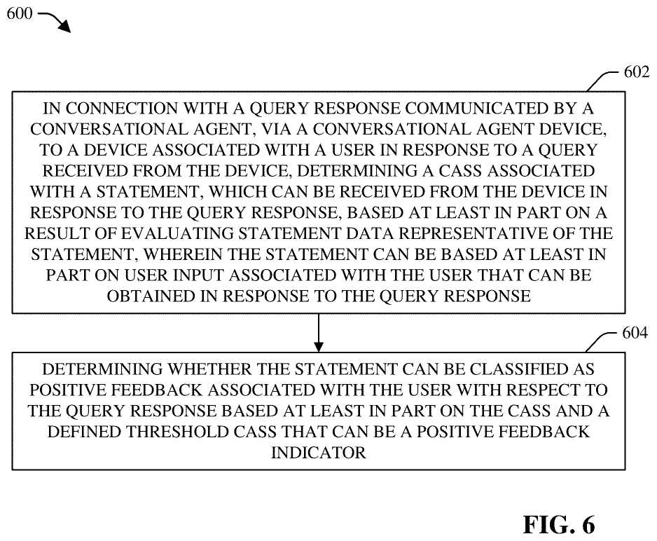

In view of the example systems and/or devices described herein, example methods that can be implemented in accordance with the disclosed subject matter can be further appreciated with reference to flowcharts in FIGS. 6-9. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 6 illustrates a flow chart of an example method 600 that can desirably (e.g., automatically, dynamically, suitably, reliably, efficiently, enhancedly, and/or optimally) determine feedback (e.g., implicit positive or negative feedback) of a user during an interaction with a conversational agent to facilitate managing, updating, and enhancing an AI-based model associated with the conversational agent, a content retrieval process, and/or the conversational agent, in accordance with various aspects and embodiments of the disclosed subject matter. The method 600 can be employed by, for example, a system comprising the interaction manager component, conversational agent, AI-based model, the processor component, the data store, and/or other components, wherein the interaction manager component can comprise various components, such as described herein.

At 602, in connection with a query response communicated by a conversational agent, via a conversational agent device, to a device associated with a user in response to a query received from the device, a CASS associated with a statement, which can be received from the device in response to the query response, can be determined based at least in part on a result of evaluating statement data representative of the statement, wherein the statement can be based at least in part on user input associated with the user that can be obtained in response to the query response. The conversational agent, via the conversation agent device, can receive the query from the user, via the device of the user. The interaction manager component can employ the AI-based model (e.g., trained AI-based model) associated with the conversational agent to determine the query response, or at least determine information that can be utilized to determine and generate the query response, based at least in part on the results of performing an AI-based analysis on a group of electronic documents determined (e.g., by the document retrieval manager component of the interaction manager component) to be relevant to the query. In response to the query, the conversational agent, via the conversational agent device, can communicate the query response to the user, via the device (e.g., which can be a communication device of the user or an interface of or associated with the conversational agent device). In some embodiments, the conversational agent can receive the statement associated with the user from the device in response to the query response. The interaction manager component, employing the score determination component, can determine (e.g., can calculate) the CASS associated with the statement based at least in part on the result of evaluating the statement data representative of the statement, such as described herein.

At 604, a determination can be made regarding whether the statement can be classified as positive feedback associated with the user with respect to the query response based at least in part on the CASS and a defined threshold CASS that can be a positive feedback indicator. In some embodiments, the interaction manager component, employing the feedback evaluator component, can determine whether the statement associated with the user can be classified as positive feedback or negative feedback associated with the user with respect to the query response based at least in part on the CASS and the defined threshold CASS, such as described herein.

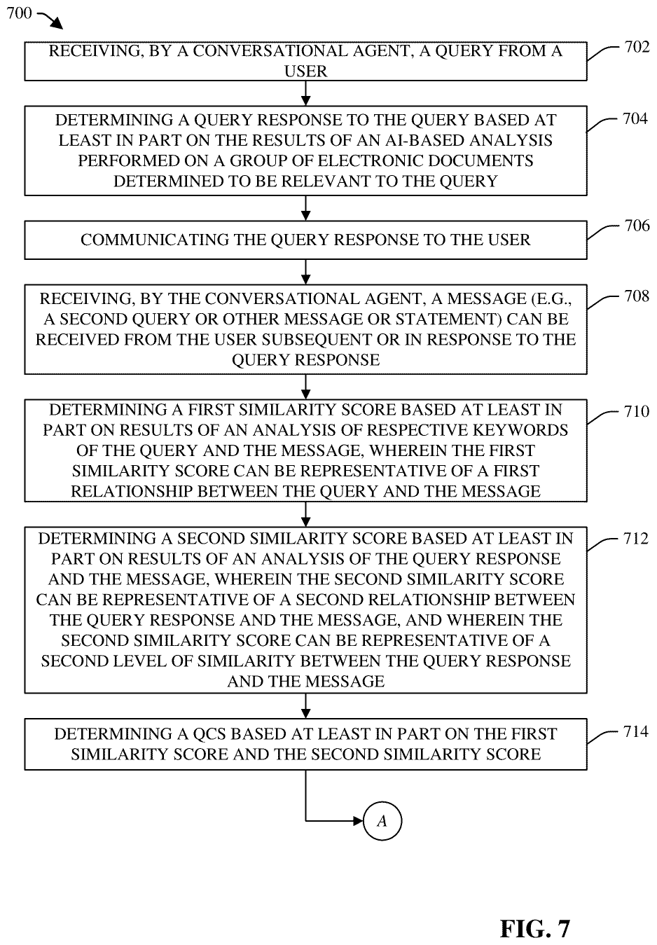

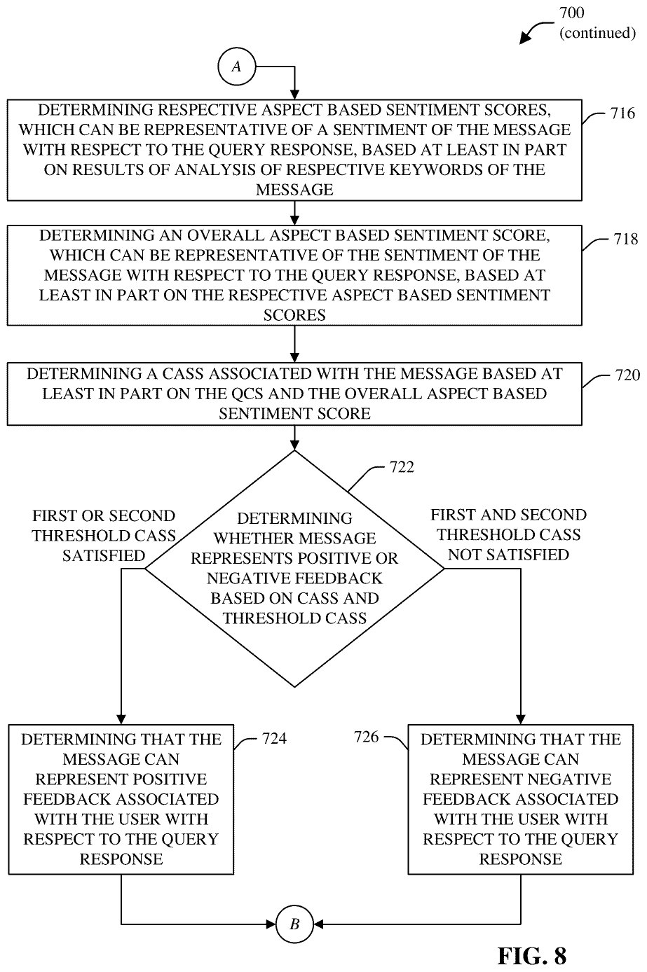

FIGS. 7 and 8 illustrate a flow chart of another example method 700 that can desirably (e.g., automatically, dynamically, suitably, reliably, efficiently, enhancedly, and/or optimally) determine feedback (e.g., implicit positive or negative feedback) of a user during an interaction with a conversational agent to facilitate managing, updating, and enhancing an AI-based model associated with the conversational agent, a content retrieval process, and/or the conversational agent, in accordance with various aspects and embodiments of the disclosed subject matter. The method 700 can be employed by, for example, a system comprising the interaction manager component, conversational agent, AI-based model, the processor component, the data store, and/or other components, wherein the interaction manager component can comprise various components, such as described herein.

At 702, a query can be received by a conversational agent from the user. For instance, the conversational agent can receive the query from the user (e.g., via the device of the user and/or via the communication network associated with (e.g., communicatively connected to) the device and the conversational agent, or via an interface of or associated with the conversational agent).

At 704, a query response to the query can be determined based at least in part on the results of an AI-based analysis performed on a group of electronic documents determined to be relevant to the query. In some embodiments, the document retrieval manager component can determine the group of documents that can be relevant to the query based at least in part on the results of analyzing the query (e.g., query information of the query). The query and the group of electronic documents can be input to the AI-based model. The AI-based model can perform an AI-based analysis on the query and the group of electronic documents. Based at least in part on the results of the AI-based analysis, the AI-based model can determine and generate query response information that can be, or can be utilized to generate, the query response to the query, and can provide (e.g., communicate) the query response and/or the query response information to the conversational agent.

At 706, the query response can be communicated to the user. For instance, the conversational agent can communicate the query response to the device of the user for presentation (e.g., display or other presentation) to the user.

At 708, a message (e.g., a second query or other message or statement) can be received from the user by the conversational agent subsequent or in response to the query response. In some embodiments, subsequent to or in response to receiving and perceiving (e.g., reading and/or evaluating) the query response, the user (e.g., via the device or interface) can communicate the message to the conversational agent, which can receive the message.

At 710, a first similarity score can be determined based at least in part on results of an analysis of respective keywords of the query and the message (e.g., the second query or other message or statement), wherein the first similarity score can be representative of a first relationship between the query and the message. In some embodiments, the interaction manager component, employing the score determination component, can determine (e.g., calculate) the first similarity score that can be representative of the first relationship between the query (e.g., query information representative of the query) and the message (e.g., message information representative of the message) based at least in part on the results of the analysis (e.g., AI-based analysis or other analysis) of the respective keywords of the query and the message, wherein the first similarity score can be representative of the first level of similarity or the level of logical continuity between the query and the message, such as described herein.

At 712, a second similarity score can be determined based at least in part on results of an analysis of the query response and the message, wherein the second similarity score can be representative of a second relationship between the query response and the message, and wherein the second similarity score can be representative of a second level of similarity between the query response and the message. In certain embodiments, the score determination component can determine the second similarity score that can be representative of the second relationship between the query response and the message based at least in part on the results of the analysis (e.g., AI-based analysis or other analysis) of the query response (e.g., query response information representative of the query response) and the message (e.g., message information representative of the message). In some embodiments, the second similarity score can be representative of the second level of similarity between the query response and the message, wherein the second level of similarity between the query response and the message can be derived (e.g., deduced by the score determination component) based at least in part on the results of such analysis, such as described herein.

At 714, a QCS can be determined based at least in part on the first similarity score and the second similarity score. In some embodiments, the score determination component can determine (e.g., calculate) the QCS based at least in part on (e.g., as a function of) the first similarity score and the second similarity score, such as described herein. In some embodiments, the method 700 can proceed to reference point A, wherein the method 700 can proceed from reference point A, such as described herein and shown in FIG. 8.

At 716, respective aspect based sentiment scores, which can be representative of a sentiment of the message with respect to the query response, can be determined based at least in part on results of analysis of respective keywords of the message. In some embodiments, the score determination component can determine (e.g., calculate) the respective aspect based sentiment scores based at least in part on the results of the analysis of the respective keywords of the message (e.g., the message information representative of the message) and/or the query response, such as described herein.

At 718, an overall aspect based sentiment score, which can be representative of the sentiment of the message with respect to the query response, can be determined based at least in part on the respective aspect based sentiment scores. In accordance with various embodiments, the score determination component can determine (e.g., calculate) the overall aspect based sentiment score based at least in part on (e.g., as a function of) the respective aspect based sentiment scores, such as described herein. For example, the score determination component can determine the overall aspect based sentiment score as a function of the average value or the median value (or the weighted average value or the weighted median value) of the respective aspect based sentiment scores.

At 720, a CASS associated with the message can be determined based at least in part on the QCS and the overall aspect based sentiment score. In some embodiments, the score determination component can determine (e.g., calculate) the CASS associated with the message based at least in part on (e.g., as a function of) the QCS and the overall aspect based sentiment score.

At 722, a determination can be made regarding whether the message represents positive feedback or negative feedback associated with the user based at least in part on the CASS and a first defined threshold CASS or a second defined threshold CASS. In accordance with various embodiments, the interaction manager component, employing the feedback evaluator component, can determine whether the message represents (e.g., can be classified as or can be indicative of) positive feedback or negative feedback associated with the user based at least in part on (e.g., as a function of) the CASS and the first defined threshold CASS or the second defined threshold CASS. For instance, the feedback evaluator component can compare the CASS to the first defined threshold CASS and/or the second defined threshold CASS (e.g., if both the first defined threshold CASS and the second defined threshold CASS are being utilized). Based at least in part on the results of such comparison, the feedback evaluator component can determine whether the CASS associated with the message satisfies the first defined threshold CASS or the second defined threshold CASS (e.g., can determine whether the CASS is at or above the first defined threshold CASS or is at or below the second defined threshold CASS).

If, based at least in part on the comparison results, it is determined that the CASS satisfies the first defined threshold CASS or the second defined threshold CASS, at 724, a determination can be made that the message can represent positive feedback associated with the user with respect to the query response. If, instead, at 722, it is determined that the CASS does not satisfy the first defined threshold CASS and the second defined threshold CASS based at least in part on the comparison results, at 726, a determination can be made that the message can represent negative feedback associated with the user with respect to the query response. In accordance with various embodiments, if the feedback evaluator component determines that the CASS satisfies the first defined threshold CASS or the second defined threshold CASS based at least in part on the comparison results, the feedback evaluator component can determine that the message can represent positive feedback associated with the user with respect to the query response. If, instead, the feedback evaluator component determines that the CASS does not satisfy the first defined threshold CASS and the second defined threshold CASS (e.g., determines that the CASS is below the first defined threshold CASS and is above the second defined threshold CASS) based at least in part on the comparison results, the feedback evaluator component can determine that the message can represent negative feedback associated with the user with respect to the query response.

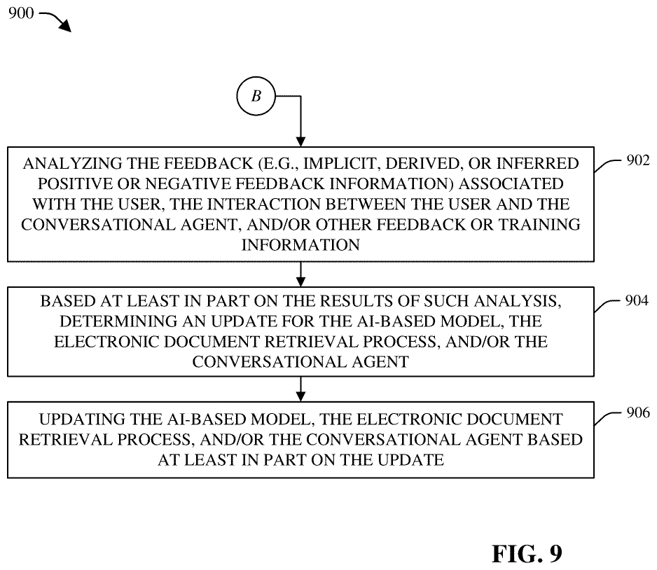

In some embodiments, at this point, the method 700 can proceed to reference point B, wherein the method 900 depicted in FIG. 9 can proceed from reference point B, such as described herein and shown in FIG. 9.

FIG. 9 depicts a flow chart of an example method 900 that can desirably (e.g., automatically, dynamically, suitably, reliably, efficiently, enhancedly, and/or optimally) update and enhance an AI-based model associated with the conversational agent, a content retrieval process, and/or the conversational agent based at least in part on feedback (e.g., implicit positive or negative feedback) of a user with respect to a query-query response interaction between the user and the conversational agent, in accordance with various aspects and embodiments of the disclosed subject matter. The method 900 can be employed by, for example, a system comprising the interaction manager component, conversational agent, AI-based model, the processor component, the data store, and/or other components, wherein the interaction manager component can comprise various components, such as described herein. In some embodiments, the method 900 can proceed from reference point B.

At 902, the feedback (e.g., implicit, derived, or inferred positive or negative feedback information) associated with the user, the interaction between the user and the conversational agent (e.g., interaction information relating to the interaction), and/or other feedback or training information can be analyzed. At 904, based at least in part on the results of such analysis, an update for the AI-based model, the electronic document retrieval process, and/or the conversational agent can be determined. The update component (and/or the feedback evaluator component) can analyze the feedback associated with the user, the interaction between the user and the conversational agent, and/or other feedback or training information. The other feedback can comprise, for example, certain user input of one or more certain users (e.g., one or more analysts, technicians, engineers, managers, or other certain users with knowledge and expertise in updating AI-based models, electronic document retrieval systems and processes, and/or conversational agents) that can relate to the feedback associated with the user (e.g., the user who submitted the query and follow-up message from which the positive or negative feedback was derived) and/or can otherwise be utilized to update and enhance the AI-based models, electronic document retrieval systems and processes, and/or conversational agents.

Based at least in part on the results of such analysis of the positive or negative feedback associated with the user, the interaction between the user and the conversational agent, and/or the other feedback or training information, the update component (and/or the feedback evaluator component) can determine and generate the update for the AI-based model, the electronic document retrieval process, and/or the conversational agent. If, for example, the feedback associated with the user is determined to be negative, the update component (and/or the feedback evaluator component) can analyze and determine the reasons for the negative feedback with regard to the interaction, can determine a desirable (e.g., suitable, enhanced, or optimal) corrective action that can rectify the problems that led to the negative feedback, and can determine an update that can enable the corrective action to be implemented. If, instead, the feedback associated with the user is determined to be positive, the update component (and/or the feedback evaluator component) can determine that no update is to be performed at this time, or, alternatively, can determine and generate a reinforcement learning update that can reinforce the positive aspects relating to the interaction between the user and the conversational agent.

At 906, the AI-based model, the electronic document retrieval process, and/or the conversational agent can be updated based at least in part on the update. For instance, the update component can respectively update (e.g., modify, adjust, or alter) or facilitate updating the AI-based model, the electronic document retrieval process, and/or the conversational agent based at least in part on the update (e.g., update information of the update), such as described herein.

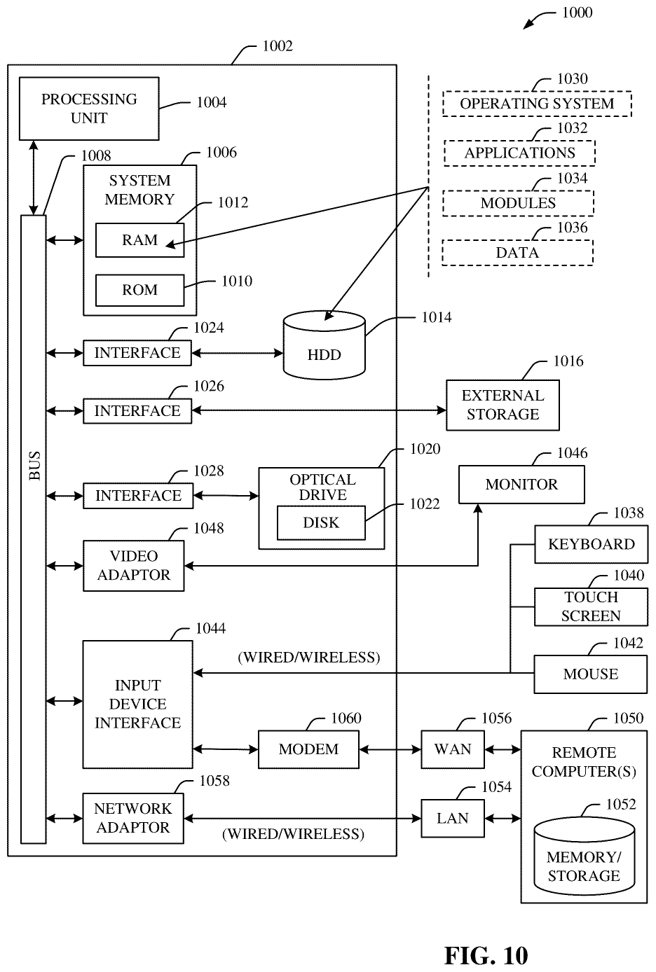

In order to provide additional context for various embodiments described herein, FIG. 10 and the following discussion are intended to provide a brief, general description of a suitable computing environment 1000 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 also can be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056, e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., interaction manager component, device, conversational agent, document retrieval manager component, model, AI component, processor component, database, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
in connection with a query response communicated by a conversational agent, via a conversational agent device, to a device associated with a user in response to a query received from the device, determining, by a system comprising at least one processor, a conditional aspect based sentiment score associated with a statement, received from the device in response to the query response, based on a result of evaluating statement data representative of the statement, wherein the statement is based on user input associated with the user that is obtained in response to the query response; and
determining, by the system, whether the statement is classified as positive feedback associated with the user with respect to the query response based on the conditional aspect based sentiment score and a defined threshold conditional aspect based sentiment score that is a positive feedback indicator.

2. The method of claim 1, wherein the query is a first query received by the conversational agent, via the conversational agent device, from the device, wherein the statement is a second query or a user response received by the conversational agent, via the conversational agent device, from the device, and wherein the second query or the user response is received in response to the query response.

3. The method of claim 1, wherein the statement comprises implicit feedback associated with the user that is not explicit feedback requested by the conversational agent.

4. The method of claim 1, further comprising:
determining, by the system, a first similarity score that indicates a first relationship between the query and the statement based on a first analysis of respective keywords of query data representative of the query and the statement data representative of the statement, wherein the first similarity score indicates a first level of similarity, or a level of logical continuity, between the query and the statement;
determining, by the system, a second similarity score that indicates a second relationship between the query response and the statement based on a second analysis of query response data representative of the query response and the statement data, wherein the second similarity score indicates a second level of similarity between the query response and the statement, and wherein the determining of the second level of similarity between the query response and the statement comprises deducing the second level of similarity based on the second analysis; and
determining, by the system, a query continuity score based on the first similarity score and the second similarity score.

5. The method of claim 4, wherein the respective keywords are respective first keywords, and wherein the method further comprises:
determining, by the system, respective aspect based sentiment scores indicative of a sentiment of the statement with respect to the query response based on a third analysis of respective second keywords of the statement data representative of the statement, wherein the respective second keywords comprise at least some of the respective first keywords; and
determining, by the system, an overall aspect based sentiment score indicative of the sentiment of the statement with respect to the query response based on the respective aspect based sentiment scores,
wherein the determining of the conditional aspect based sentiment score associated with the statement comprises determining the conditional aspect based sentiment score associated with the statement based on the query continuity score and the overall aspect based sentiment score.

6. The method of claim 5, wherein the determining of the overall aspect based sentiment score indicative of the sentiment of the statement with respect to the query response based on the respective aspect based sentiment scores comprises determining the overall aspect based sentiment score based on an average value or a median value of the respective aspect based sentiment scores.

7. The method of claim 1, further comprising:
determining, by the system, that the conditional aspect based sentiment score associated with the statement satisfies the defined threshold conditional aspect based sentiment score; and
classifying, by the system, that the statement represents the positive feedback based on determining that the conditional aspect based sentiment score associated with the statement satisfies the defined threshold conditional aspect based sentiment score.

8. The method of claim 1, wherein the defined threshold conditional aspect based sentiment score is a first defined threshold conditional aspect based sentiment score, and wherein the method further comprises:
determining, by the system, that the conditional aspect based sentiment score associated with the statement is at or lower than, and resultingly satisfies, a second defined threshold conditional aspect based sentiment score that is lower than the first defined threshold conditional aspect based sentiment score, and
classifying, by the system, that the statement represents the positive feedback with respect to the query response based on determining that the conditional aspect based sentiment score associated with the statement satisfies the second defined threshold conditional aspect based sentiment score; or
determining, by the system, that the conditional aspect based sentiment score associated with the statement is lower than the first second defined threshold conditional aspect based sentiment score and higher than the second defined threshold conditional aspect based sentiment score, and resultingly does not satisfy the first second defined threshold conditional aspect based sentiment score and the second defined threshold conditional aspect based sentiment score, and
classifying, by the system, that the statement represents negative feedback associated with the user, and does not represent the positive feedback, with respect to the query response based on determining that the conditional aspect based sentiment score associated with the statement does not satisfy the first second defined threshold conditional aspect based sentiment score and the second defined threshold conditional aspect based sentiment score.

9. The method of claim 1, wherein the conversational agent comprises or is associated with a trained artificial intelligence-based model, and wherein the method further comprises:
determining, using the trained artificial intelligence-based model of the system, first query response data relating to the query response based on an artificial intelligence-based analysis of query data relating to the query and document data of a group of electronic documents, wherein the group of electronic documents is determined to be relevant to the query and is retrieved, utilizing an electronic document retrieval process, in connection with the query; and
communicating, by the conversational agent of the system, via the conversational agent device, second query response data relating to the query response to the device for rendering to the user, wherein the second query response data is the first query response data or is based on the first query response data.

10. The method of claim 9, wherein the result is a first result, and wherein the method further comprises:
determining, by the system, a modification to the trained artificial intelligence-based model, the electronic document retrieval process, or the conversational agent based on a second result of determining whether the statement is classified as the positive feedback associated with the user with respect to the query response, wherein the second result indicates whether the statement is classified as the positive feedback or negative feedback associated with the user with respect to the query response; and
modifying, by the system, the trained artificial intelligence-based model, the electronic document retrieval process, or the conversational agent based on modification data of the modification to facilitate refining the trained artificial intelligence-based model, the electronic document retrieval process, or the conversational agent.

11. A system, comprising:
at least one memory that stores computer executable components; and
at least one processor that executes computer executable components stored in the at least one memory, wherein the computer executable components comprise:
a score determinator that, with regard to a query response transmitted by a conversational agent, via a first device, to a second device associated with a user in response to a query received from the second device, determines a conditional aspect based sentiment score associated with a message received, via the second device based on input from the user, in response to the query response, based on a result of an analysis of message information representative of the message; and
a feedback evaluator that determines whether the message is representative of positive feedback associated with the user with respect to the query response based on the conditional aspect based sentiment score and a defined threshold conditional aspect based sentiment score that indicates whether feedback is positive.

12. The system of claim 11, wherein the input is second input, wherein the query is a first query received by the conversational agent, via the first device, based on first input from the user, via the second device, wherein the message is a second query or a user response received by the conversational agent, via the first device, based on the second input from the user, via the second device, wherein the second query or the user response is received in response to the query response, and wherein the message is representative of implicit feedback associated with the user that is not explicit feedback requested or solicited by the conversational agent from the user.

13. The system of claim 11, wherein the analysis is a third analysis, wherein the result is a third result, wherein the score determinator determines a first similarity score that is representative of a first relationship between the query and the message based on a first result of a first analysis of respective keywords of query information representative of the query and the message information representative of the message, wherein the first similarity score is representative of a first level of similarity or a level of logical continuity between the query and the message,
wherein the score determinator determines a second similarity score that is representative of a second relationship between the query response and the message based on a second result of a second analysis of query response information representative of the query response and the message information, wherein the second similarity score is representative of a second level of similarity between the query response and the message, wherein the second level of similarity between the query response and the message is derived based on the second result of the second analysis, and
wherein the score determinator determines a query continuity score as a function of the first similarity score and the second similarity score.

14. The system of claim 13, wherein the respective keywords are respective first keywords, wherein the score determinator determines respective aspect based sentiment scores representative of a sentiment of the message with respect to the query response based on a fourth result of a fourth analysis of respective second keywords of the message information representative of the message, wherein the respective second keywords comprise at least some of the respective first keywords,
wherein the score determinator determines an overall aspect based sentiment score representative of the sentiment of the message with respect to the query response as a function of the respective aspect based sentiment scores, wherein the score determinator determines the overall aspect based sentiment score as a function of an average value or a median value of the respective aspect based sentiment scores, and
wherein the score determinator determines the conditional aspect based sentiment score associated with the message as a function of the query continuity score and the overall aspect based sentiment score.

15. The system of claim 11, wherein the feedback evaluator determines that the conditional aspect based sentiment score associated with the message satisfies the defined threshold conditional aspect based sentiment score, and, based on the conditional aspect based sentiment score being determined to satisfy the defined threshold conditional aspect based sentiment score, determines that the message is representative of the positive feedback.

16. The system of claim 11, wherein the defined threshold conditional aspect based sentiment score is a first defined threshold conditional aspect based sentiment score, wherein
one of:
the feedback evaluator determines that the conditional aspect based sentiment score associated with the message is at or lower than, and resultingly satisfies, a second defined threshold conditional aspect based sentiment score that is lower than the first defined threshold conditional aspect based sentiment score, and, based on the conditional aspect based sentiment score being determined to satisfy the second defined threshold conditional aspect based sentiment score, determines that the message is representative of the positive feedback with respect to the query response; or
the feedback evaluator determines that the conditional aspect based sentiment score associated with the message is lower than the first second defined threshold conditional aspect based sentiment score and higher than the second defined threshold conditional aspect based sentiment score, and resultingly does not satisfy the first second defined threshold conditional aspect based sentiment score and the second defined threshold conditional aspect based sentiment score, and, based on the conditional aspect based sentiment score being determined to not satisfy the first second defined threshold conditional aspect based sentiment score and the second defined threshold conditional aspect based sentiment score, determines that the message is representative of negative feedback associated with the user, and is not representative of the positive feedback, with respect to the query response.

17. The system of claim 11, wherein the conversational agent comprises or is associated with a trained artificial intelligence-based model, wherein the trained artificial intelligence-based model determines first query response information relating to the query response based on an artificial intelligence-based analysis of query information relating to the query and document information of a group of electronic documents determined to be associated with the query,
wherein the conversational agent transmits, via the first device, second query response information relating to the query response to the second device for presentation to the user, and wherein the second query response information is the first query response information or is based on the first query response information.

18. The system of claim 17, wherein the result is a first result, wherein the computer executable components comprise:
an updater that determines an update to the trained artificial intelligence-based model, the conversational agent, or a retrieval procedure for retrieval of electronic documents in response to queries based on a second result of the determination of whether the message is representative of the positive feedback associated with the user with respect to the query response, wherein the second result indicates whether the message is representative of the positive feedback or negative feedback associated with the user with respect to the query response, and
wherein the updater updates the trained artificial intelligence-based model, the conversational agent, or the retrieval procedure based on update information of the update to facilitate enhancing the trained artificial intelligence-based model, the conversational agent, or the retrieval procedure.

19. A non-transitory machine-readable medium, comprising executable instructions that, when executed by at least one processor, facilitate performance of operations, comprising:
with regard to a query response communicated by an interactive agent, via a first device, to a second device, associated with a user identity that identifies a user, in response to a first query received from the second device, determining a conditional aspect based sentiment value associated with a message received from the second device in response to the query response based on a result of analyzing message information representative of the message associated with the user identity, wherein the message is a second query or a user response to the query response; and
determining whether the message is indicative of positive feedback or negative feedback associated with the user identity with respect to the query response based on the conditional aspect based sentiment value and a defined threshold conditional aspect based sentiment criterion that is indicative of feedback types comprising the positive feedback and the negative feedback.

20. The non-transitory machine-readable medium of claim 19, wherein the interactive agent comprises or is associated with a trained artificial intelligence-based model, wherein the result is a first result, and wherein the operations further comprise:
determining, using the trained artificial intelligence-based model, first query response information relating to the query response based on an artificial intelligence-based analysis of query information relating to the query and document information of a group of electronic documents retrieved to facilitate the artificial intelligence-based analysis in connection with the query;
communicating, by the interactive agent, via the first device, second query response information relating to the query response to the second device associated with the user identity, wherein the second query response information is the first query response information or is based on the first query response information;
determining an update to the trained artificial intelligence-based model, the interactive agent, or a retrieval process for retrieving electronic documents in response to queries based on a second result of determining whether the message is classified as the positive feedback or the negative feedback associated with the user identity with respect to the query response, wherein the second result indicates whether the message is classified as the positive feedback or the negative feedback; and
modifying the trained artificial intelligence-based model, the interactive agent, or the retrieval process based on update information of the update to facilitate refining the trained artificial intelligence-based model, the interactive agent, or the retrieval process.
